(19) United States
(12) Patent Application Publication
(10) Pub. No.: US 2026/0342634 A1
(43) Pub. Date: Oct. 29, 2026

(54) USER ACTIVITY DETECTION

(71) Applicant: Nokia Technologies Oy, Espoo (FI)

(72) Inventor: Haiyou GUO, Shanghai (CN)

(21) Appl. No.: 19/118,977

(22) PCT Filed: Oct. 17, 2022
(86) PCT No.: PCT/CN2022/125763

§ 371 Date: Apr. 7, 2025

(51) Int. Cl. H04L 27/26

(52) U.S. Cl. CPC H04L 27/2646; H04L 27/2605

(57) ABSTRACT

Embodiments of the present disclosure relate to methods and apparatus for User Activity Detection (UAD). A terminal device receives, from a network device in the radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and transmits a modulated conjugated symmetric signal, wherein the modulated conjugated symmetric signal is generated by modulating a subcarrier from the set of subcarriers with a symbol and the modulated conjugated symmetric signal comprises a sparse Multicarrier Faster Than Nyquist (MC-FTN) conjugated symmetric signaling. In this way, a new solution for UAD for massive access with reduced latency and reduced cost of measurement resource is provided.

### FIELD

Various example embodiments relate to the field of telecommunication and in particular, to methods, devices, apparatuses and a computer readable storage medium for User Activity Detection (UAD).

### BACKGROUND

With the development of communication technologies, the future society will become digitalized and data-driven, for example through connected industries, intelligent transportation systems, smart cities, etc., thus providing greater convenience for daily life and industrial development. Machine Type Communication (MTC) is able to support massive connections, thus providing a possible approach to realize such a digitalized and data-driven society. Alongside, further development of the society will give rise to new and more stringent requirements on wireless connectivity. Enhancements on UAD for MTC are still needed.

### SUMMARY

In general, example embodiments of the present disclosure provide a solution for performing UAD.

In a first aspect, there is provided a terminal device in a radio access network. The terminal device may comprise at least one processor and at least one memory storing instructions. The instructions, when executed by the at least one processor, cause the terminal device at least to: receive, from a network device in the radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and transmit, to the network device, a modulated conjugated symmetric signal, wherein the modulated conjugated symmetric signal is generated by modulating a subcarrier from the set of subcarriers with a symbol and the modulated conjugated symmetric signal comprises a sparse Multicarrier Faster Than Nyquist (MC-FTN) conjugated symmetric signaling.

In a second aspect, there is provided a network device in a radio access network. The network device may comprise at least one processor and at least one memory storing instructions. The instructions, when executed by the at least one processor, cause the terminal device at least to: transmit, to a set of terminal devices in the radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; receive a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and identify the set of active terminal devices out of the set of terminal devices based on the received superimposed signal.

In a third aspect, there is provided a method. The method may comprise receiving, at a terminal device from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and transmitting, to the network device, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In a fourth aspect, there is provided a method. The method may comprise transmitting, at a network device to a set of terminal devices in a radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; receiving a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and identifying the set of active terminal devices out of the set of terminal devices based on the received superimposed signal.

In a fifth aspect, there is provided an apparatus. The apparatus may comprise: means for receiving, at a terminal device from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and means for transmitting, to the network device, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In a sixth aspect, there is provided an apparatus. The apparatus may comprise: means for transmitting, at a network device to a set of terminal devices in a radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; means for receiving a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and means for identifying the set of active terminal devices out of the set of terminal devices based on the received superimposed signal.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, from a network device in the radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and transmit, to the network device, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In a ninth aspect, there is provided a computer program comprising instructions, which, when executed by an apparatus, cause the apparatus at least to: transmit, to a set of terminal devices in the radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; receive a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and identify the set of active terminal devices out of the set of terminal devices based on the received superimposed signal.

In a tenth aspect, there is provided a terminal device in a radio access network. The terminal device may comprise: receiving circuitry configured to receive, from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and transmitting circuitry configured to transmit, to the network device, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In an eleventh aspect, there is provided a network device in a radio access network. The network device may comprise: transmitting circuitry configured to transmit, to a set of terminal devices in a radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; receiving circuitry configured to receive a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and identifying circuitry configured to identify the set of active terminal devices out of the set of terminal devices based on the received superimposed signal.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication network in which embodiments of the present disclosure may be implemented;

FIG. 1B illustrates a schematic diagram illustrating an effective uplink (UL) Channel Impulse Response (CIR) in random access scenarios according to some embodiments of the present disclosure;

FIG. 2 illustrates a schematic diagram illustrating a process for communication according to some embodiments of the present disclosure;

FIG. 3A illustrates an example diagram of data signals and UAD signals in time domain according to some embodiments of the present disclosure;

FIG. 3B illustrates an example diagram of a multiplexing structure of data signals and UAD signals in frequency domain according to some embodiments of the present disclosure;

FIG. 4A illustrates an example diagram of phase-estimation error based on partial priori knowledge on the corresponding UL channel according to some embodiments of the present disclosure;

FIG. 4B illustrates an example diagram of a phase-compensation factor design according to some embodiments of the present disclosure;

FIG. 4C illustrates an example diagram of a reconstruction condition on the sign of imaginary parts of the received symbols in the subcarriers according to some embodiments of the present disclosure;

FIG. 5 illustrates an example diagram of a transmission procedure of a modulated conjugated symmetric signal according to some embodiments of the present disclosure;

FIG. 6 illustrates an example diagram of a procedure of generating a discrete-time baseband conjugated symmetric signal according to some embodiments of the present disclosure;

FIG. 7A illustrates an example diagram of transmission of downlink (DL) beacon signal in the communication network according to some embodiments of the present disclosure;

FIG. 7B illustrates an example diagram of pre-compensation procedure for UL Carrier Phase Offset (CPO) according to some embodiments of the present disclosure;

FIG. 8 illustrates an example diagram of a reception procedure of superimposed MC-FTN conjugated symmetric signaling according to some embodiments of the present disclosure;

FIG. 9 illustrates an example implementation of a process for joint UAD and timing acquisition algorithm according to embodiments of the present disclosure;

FIG. 10 illustrates an example implementation of a process for communication according to embodiments of the present disclosure;

FIG. 11A illustrates an example implementation of MC-FTN conjugated symmetric signaling in frequency domain according to some embodiments of the present disclosure;

FIG. 11B illustrates an example diagram of conventional Physical Layer Random Access Channel (PRACH) signals in frequency domain;

FIG. 11C illustrates an example diagram of MC-FTN conjugated symmetric signals and conventional PRACH signals in time domain according to some embodiments of the present disclosure;

FIGS. 12A and 12B illustrate a joint UAD and timing acquisition performance comparison between MC-FTN conjugated symmetric signaling in accordance with some embodiments of the present disclosure and conventional PRACH procedure via Zadoff-Chu (ZC) sequence under the same time-frequency resource;

FIG. 13 illustrates a flowchart of a method implemented at a terminal device according to some embodiments of the present disclosure;

FIG. 14 illustrates a flowchart of a method implemented at a network device according to some embodiments of the present disclosure;

FIG. 15 illustrates a simplified block diagram of an apparatus that is suitable for implementing embodiments of the present disclosure; and

FIG. 16 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G), or the further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a Base Station (BS) or an Access Point (AP), for example, a Node B (NodeB or NB), an evolved NodeB (eNodeB or eNB), a NR NB (also referred to as a gNB), a Remote Radio Unit (RRU), a Radio Header (RH), a Remote Radio Head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, User Equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a Personal Digital Assistant (PDA), portable computers, desktop computer, image capture terminal devices such as digital cameras, gaming terminal devices, music storage and playback appliances, vehicle-mounted wireless terminal devices, wireless endpoints, mobile stations, Laptop-Embedded Equipment (LEE), Laptop-Mounted Equipment (LME), USB dongles, smart devices, wireless Customer-Premises Equipment (CPE), an Internet of Things (IoT) device, a watch or other wearable, a Head-Mounted Display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably. In the following description, the terms “preamble”, “sequence”, “waveform” and “signal” may be used interchangeably.

MTC in 5G is split into Ultra-Reliable and Low Latency Communications (URLLC) or critical MTC (cMTC) in controlled environments with small-payloads and low-data rates, and Massive MTC (mMTC) for large/dense deployments with sporadic traffic patterns. In the coming decade, owing to emerging industrial use cases and the verticalization of the service provision, these two domains will develop into several specialized subclasses, hence demanding multi-dimensional optimization and scalable designs. With the development of communication technology, evolved techniques are needed to serve highly diverse applications ranging from data-rate hungry holographic images and connected 360 XR (Augmented/Virtual/Mixed Reality) to massive access for various types of IoT devices. One of MTC service classes for 6G is proposed to be classified as scalable critical MTC (cMTC), which refers to supporting massive connectivity with high reliability and low latency, e.g. critical medical monitoring and factory automation. Scale and flexibility will continue to be important measures for 6G performance. 6G communication is expected to support as high connection density as 10 million devices per km².

As opposed to human-centric communications, machine-centric communications (e.g. scalable cMTC) generally possesses two distinctive features. On the one hand, the overall system needs to support massive connectivity—the number of terminal devices connected to a cellular network device may be in the order of 10⁴ to 10⁷. The macro network device prefers to provide a unified massive access for various types of IoT devices, offering a low-cost solution for supporting massive connectivity with high reliability and low latency. Commercially, the telecommunication vendors favor a unified solution. On the other hand, the traffic pattern is sporadic—at any given time only a small fraction of potential terminal devices are active. Typically, the machine-type terminal devices connect asynchronously and sporadically to a network device to send small data payloads. The sporadicity is due to the inherent burstiness of event-driven IoT communications in controlled and/or sensing environments. Most of the machine-type terminal devices make random requests independently, with less periodicity being able to be tracked and utilized. As such, it is impossible for the network device to predict when and which terminal device will deliver data packet in advance.

One of the major obstacles for the proliferation of efficient cellular access for scalable cMTC stems from the deficiencies of the access reservation procedure, a key building block of the cellular access networking. From 1G to 5G, the access reservation procedure is designed to enable connection establishment for a relatively low number of accessing terminal devices. Additionally, each terminal device has moderate to high data-rate requirements such that the overhead of current access protocols with multiple phases is relatively small. Both assumptions, the low number of terminal devices as well as moderate to high data rates, are in contradiction to scalable cMTC needs. The conventional access reservation procedure adopts random access to establish connection state for terminal devices at the cost of access latency of about 20 ms, such as Physical Layer Random Access Channel (PRACH) in LTE/NR.

The conventional random access procedure fulfils two necessary functions preparing for successful communication, i.e., UAD and timing acquisition. On the one hand, the network device needs to identify the active subset out of entire terminal devices under primitive (idle) state, prior to establishing successful connections between the terminal devices and the network device. On the other hand, the network device needs to estimate the propagation delays experienced by the identified terminal devices so that it can provide the exact Timing Advance (TA) information to all active terminal devices and enable synchronous UL transmissions. Based on UAD and timing acquisition, the connection state of the terminal device may be established and then either the scheduling-based or the grant-free (GF) data service can be applied.

Considering scarcity in frequency resource, however, the conventional random access is unscalable and inapplicable for massive and critical MTC. For example, due to limited number of preambles for PRACH, the PRACH mechanism imposes a limit on the number of active terminal devices that are granted to access the network device. In addition, a certain coherence time-frequency block just can support a fewer number of orthogonal preamble sequences relative to the massive number of machine-type terminal devices. For instance, LTE/NR only supports 64 643-length orthogonal Zadoff-Chu (ZC) sequences for PRACH. Massive terminal devices undertake random access by independently picking one sequence out of the same small set, inevitably causing serious collision, and incurring intolerable access delay. Moreover, the repeating cycles of transmission-collision-retransmission lead to an endless cascade of signaling exchange between terminal devices and the network device, which is much higher relative to a small packet a machine-type terminal device intends to send. On the other hand, maintaining connection state simultaneously for the massive terminal devices having potential service requests sustains relentless exchanges of periodic signaling, coming at the unacceptable waste in power and spectrum. It will become infeasible, as connection density increases to 10 million terminal devices/km². Also, maintaining continuous connection state is energy inefficient for an IoT device itself, the device is usually expected to have long battery life more than 10 years. If a network device has the capability of fast connection-state establishment in an on-demand fashion, the maintaining cost can be avoided.

Considering the unsustainable spectrum consumption and the low performance due to the lack of orthogonal preambles, conventional PRACH procedure is unscalable and inapplicable to massive access with low traffic intensity, as the number of concurrent access terminal devices scales up especially for massive delay-sensitive IoT access.

In fact, in scenarios with massive number of potential terminal devices but the limited coherence time and frequency dimensions in the wireless fading channel, it is impossible to assign orthogonal preambles to all terminal devices. However, non-orthogonal preamble set are superimposed and cause significant multi-user interference, e.g., when a simple matched filtering or correlation-based processing is applied at the network device, which makes the UAD and timing acquisition much challenging.

Therefore, a new solution to manage with the uncertain and random access in a more efficient and effective way is needed.

To overcome the deficiencies in the conventional methods, the present disclosure provides a holistic design from waveform design and its transmission method at the terminal device side to the reception method at the network device side. Principle and example embodiments of the present disclosure will be described in detail below with reference to the accompanying drawings. However, it is to be noted that these embodiments are illustrated as examples and not intended to limit scope of the present application in any way.

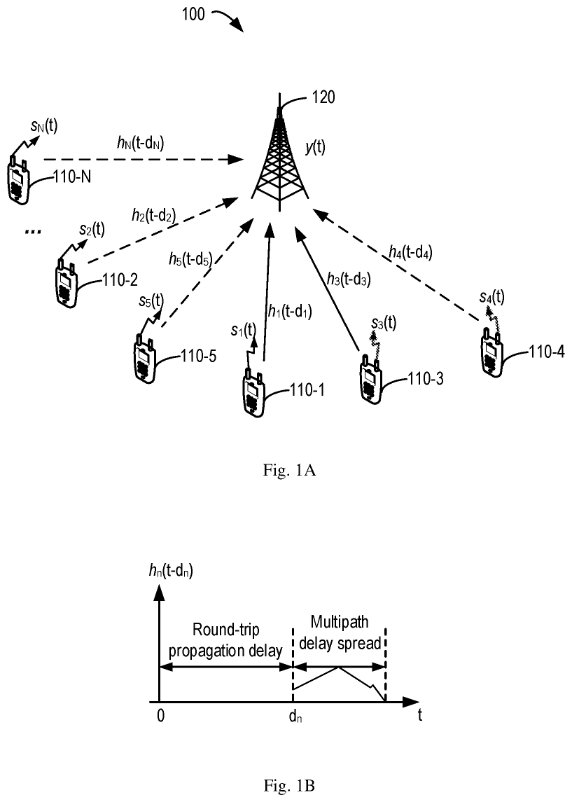

Reference is first made to FIG. 1A, which illustrates an example communication network 100 in which embodiments of the present disclosure may be implemented. As illustrated in FIG. 1A, the network 100 may include a network device 120. The network device 120 may provide a cellular network for massive access. As shown in FIG. 1A, the network 100 may further include terminal devices 110-1, 110-2, 110-3, 110-4, 110-5, . . . , 110-N, which can be collectively referred to as “terminal device(s) 110”. The set of N terminal devices be denoted by S. The number N can be any suitable integer numbers.

Without loss generality, N may be assumed to be an even and positive number. The terminal devices may be labelled by

$$n ∈ S = \{ - \frac{N}{2} , … , - 1 , 1 , … , \frac{N}{2} \} ,$$

respectively.

It is to be understood that, the number of network devices and terminal devices shown in FIG. 1A is only for the purpose of illustration without suggesting any limitations. The network 100 may include any suitable number of network devices and terminal devices adapted for implementing embodiments of the present disclosure.

The terminal devices 110 may access the network device 120 independently and asynchronously according to their own requirements of sporadic traffic, typically to request set-up of a connection and commonly referred to as random access. In an example scenario, a small fraction of potential terminal devices, denoted by an active subset S_{A} ⊆S, may become active and undertake random access procedure by sending UL preamble signals at a given transmission cycle. For example, as shown in FIG. 1A, the first terminal device 110-1 and the third terminal device 110-3 may be active while the second, fourth and fifth terminal devices 110-2, 110-4 and 110-5 are inactive. To carry out random access, in contrast to the conventional PRACH scheme with sequence collision, each terminal device 110 in the network 100 may be preassigned with a unique preamble. This preamble may also serve as the ID for this terminal device.

The network device 120 may be configured to identify the active subset S_{A} out of entire set of terminal devices S through a UAD procedure, prior to building successful connections between the terminal devices and the network device. Once the network device 120 knows which terminal device becomes active at the beginning of one transmission cycle, the network device 120 may immediately assign the identified active terminal devices with UL channels so that the active terminal devices may further provide more detailed information to the network device 120, for example, for connection-state establishment. In addition, the network device 120 may be configured to estimate the propagation delays experienced by the identified terminal devices, thus providing TA information to the identified terminal devices and enabling synchronous UL transmissions. In this way, the network device 120 is able to quickly know which terminal device becomes active at the beginning of one transmission cycle and quickly derive the respective TA information, thus a prompt response can be prepared for building a successful connection.

For the purpose of illustration, without suggesting any limitation, each terminal device 110 may be equipped with a single transmit antenna. As shown in FIG. 1A, an active terminal device n∈S_{A} ⊆S may send a baseband preamble signal sₙ(t) with a carrier signal. The baseband preamble signal sₙ(t) sent from the active terminal device n may be UE-exclusive or randomly chosen from a preamble set.

In some embodiments, the transmission of all UL preambles may be trigged/synchronized by a common DL beacon signal transmitted from the network device 120 at a starting time. FIG. 1B illustrates a schematic diagram illustrating an effective uplink Channel Impulse Response (CIR) in random access scenarios according to some embodiments of the present disclosure. For example, a common DL beacon signal may be transmitted from the network device 120 at t=0. In response to receiving the common DL beacon signal, the active terminal device n may be triggered to transmit the preamble signal sₙ(t) to the network device 120. In this way, the signal sₙ(t) would experience a round-trip propagation delay, denoted by do in second, with respect to the starting time and reach the network device 120. The signal sₙ(t) may go through a multipath spread channel from the terminal device n to the network device 120, the CIR of which may be represented by hₙ(t)∈ [symbol] . Here, the network device 120 may be assumed to be equipped with a single receive antenna. Thus, the effective UL CIR from the terminal device n to the network device 120 may be modelled by hₙ(t−dₙ), as shown in FIG. 1B.

Turning back to FIG. 1A, the network device 120 may receive an asynchronous and superimposed Radio Frequency (RF) signal. The received superimposed signal may be written as y(t)=Σ_{n∈s}_{_{A}}(sₙ(t−dₙ)e^{j(2πf}^{_{c}}^{t-Ø}^{ₙ}⁾)*hₙ(t)+n(t), where * denotes the operation of convolution, f_{c} is the carrier frequency in Hz, and n(t) denotes the additive disturbance including the thermal noise and the inter-cell interference.

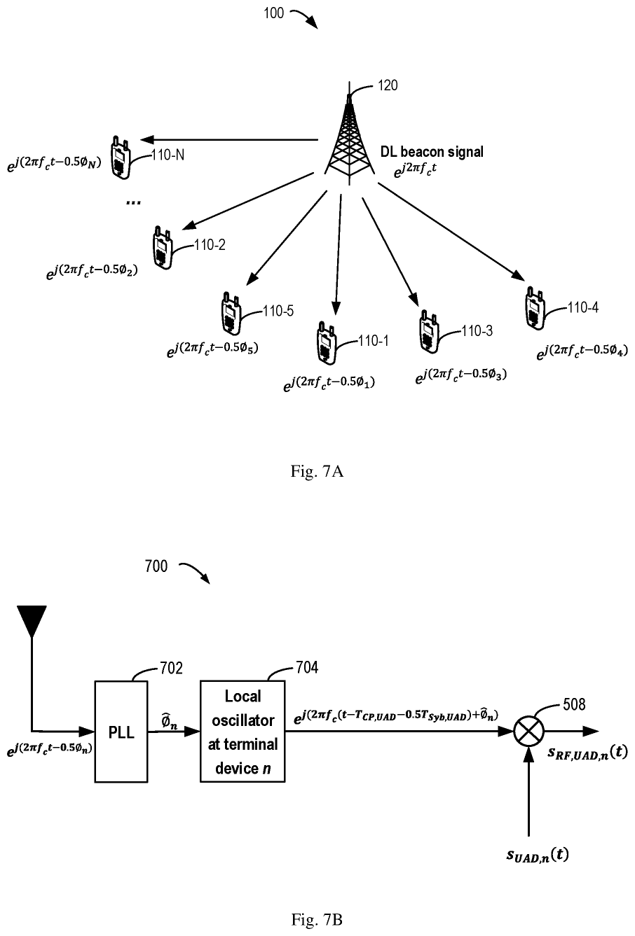

Note that the propagation delay information is conveyed not only by the base-band signal in terms of sₙ(t−dₙ), but also by the carrier signal in terms of UL CPO Øₙ where Øₙ=2πf_{c}dₙ. In other words, the propagation delay not only causes the time delay in the baseband signal but also the UL CPO in the carrier signal. The signals transmitted from different terminal devices 110 may suffer different UL CPOs, respectively. The superimposed signal received by the network device 120 might thus contain multiple independent UL CPOs. It is difficult for the network device 120 to track and compensate multiple independent UL CPOs simultaneously. In some embodiments, the UL CPO in the carrier signal introduced by the propagation delay from the terminal devices 110 to the network device 120 may be pre-compensated at the terminal device side, which facilitates the network device to identify the active subset and estimate the related propagation delay. Details of an example pre-compensation method for UL CPO will be described below in detail in connection with FIGS. 7A-7B.

At each transmission cycle, the network device 120 may identify the knowledge of the active subset S_{A} and acquire the pertained timing information of {dₙ}_{n∈s}_{_{A}}, merely depending on the observation y(t). The former is an UAD problem with respect to a discrete random variable, while the latter is a continuous estimation problem on the propagation delay.

In contrast to the conventional PRACH schemes with orthogonality among the preambles (such as ZC sequences), non-orthogonal preamble set makes the joint UAD and timing acquisition much challenging, as they would superimpose and cause severe multi-user interference, e.g., when a simple matched filtering or correlation-based processing is applied at the network device. Moreover, the effect of UL CPO prevents the exact timing acquisition from the phase estimation. Embodiments of the present disclosure provide the preamble set {sₙ(t)}_{n∈S} and related detection and estimation in a holistic way.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

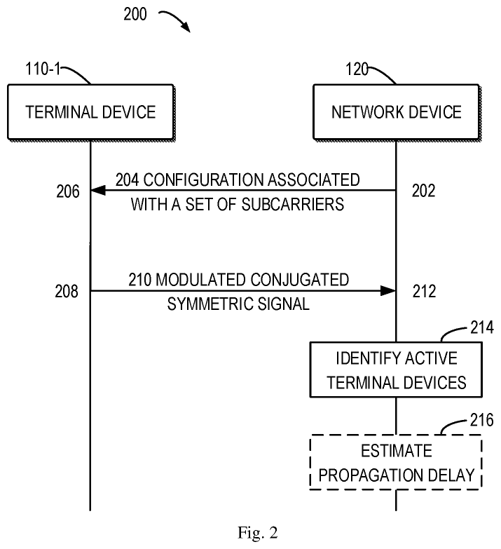

Reference is now made to FIG. 2, which illustrates a schematic diagram illustrating a process 200 for communication according to some embodiments of the present disclosure. For the purpose of discussion, the process 200 will be described with reference to FIG. 1A. The network device 120 and the terminal device 110-1 may be involved in the process 200 for the purpose of illustration.

In the process 200, the network device 120 transmits 202 a configuration 204 associated with a set of subcarriers to the set of terminal devices S in the radio access network. The set of subcarriers are associated with the set of terminal devices S for transmission of modulated conjugated symmetric signals. The modulated conjugated symmetric signals are indicative of activity information of the set of active terminal devices S_{A} out of the set of terminal devices S. In some embodiments, based on the configuration 204, all potential terminal devices 110 in the set of terminal devices S may be assigned with a specific subcarrier. When any terminal device among the set of terminal devices S becomes active, the terminal device may transmit a preamble signal in a subcarrier associated with the terminal device to perform a random access procedure.

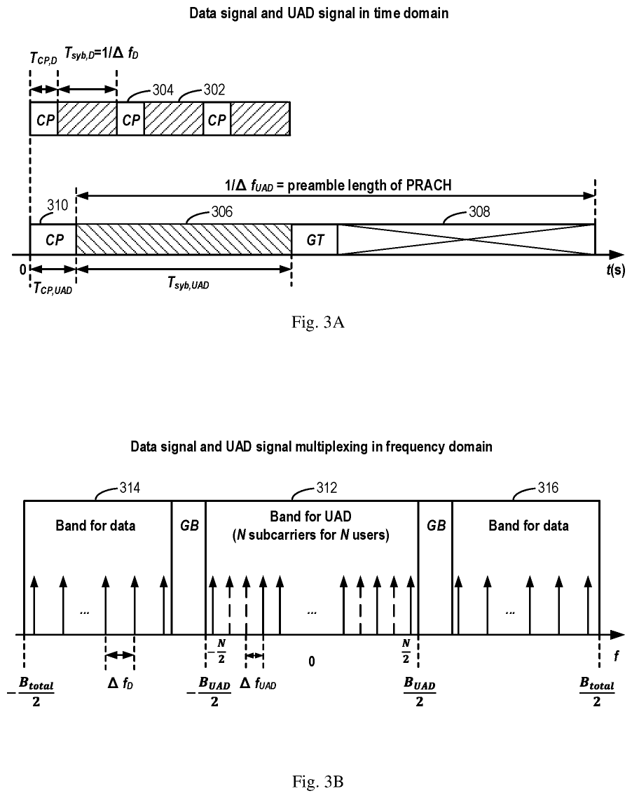

As shown in FIG. 2, the terminal device 110-1 receives 206 the configuration 204 and transmits 208 a modulated conjugated symmetric signals 210 to the network device 120. The modulated conjugated symmetric signal 210 is generated by modulating a subcarrier from the set of subcarriers with a symbol. The modulated conjugated symmetric signals 210 comprises a sparse MC-FTN conjugated symmetric signaling associated with {sₙ(t)}_{n∈S}, where the sparsity is caused by the sporadic transmission of the set of active terminal devices. The required time-frequency cost for the signal set {sₙ(t)}_{n∈S} may be evaluated in terms of Normalized Time-Bandwidth (NTB) product, i.e.,

$$NTB = \frac{1}{N} {\sum }_{n ∈ S} {T}_{n} {B}_{n} ,$$

where Bₙ and Tₙ are bandwidth and symbol time duration of preamble sₙ(t), respectively. The smaller the NTB product, the lower the time-frequency resource spent. Any orthogonal design requires adequate time-frequency resource such that NTB≥1. MC-FTN conjugated symmetric signaling allows for a shorter symbol time duration less than the reciprocal of the subcarrier spacing, resulting in a reduction in the unavoidable latency penalty. Meanwhile, the requirement NTB≤1 for MC-FTN conjugated symmetric signaling design indicates that the modulated conjugated symmetric signals associated with {sₙ(t)}_{n∈S} from different terminal devices among the set of terminal devices S are non-orthogonal. Details of an example MC-FTN conjugated symmetric signaling design will be described below in detail in connection with FIGS. 3A-6.

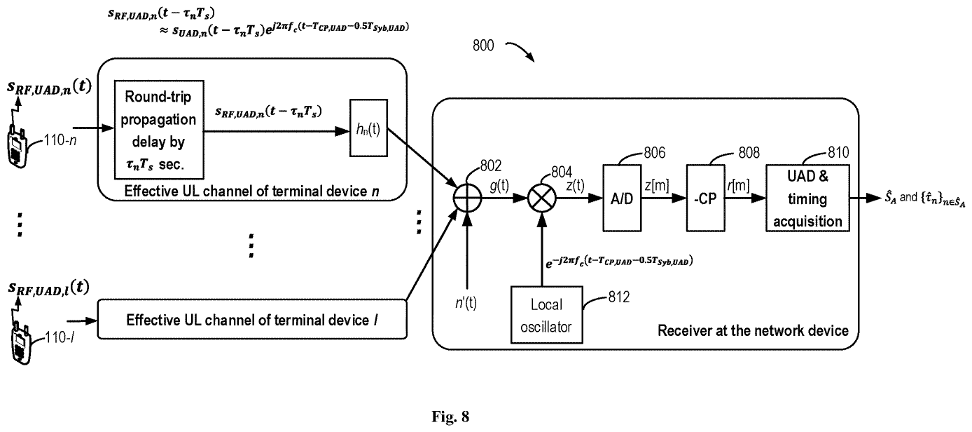

The network device 120 receives 212 the modulated conjugated symmetric signals 210 from the terminal device 110-1 and other modulated conjugated symmetric signals from other active terminal devices if any. From the perspective view of the network device 120, the network device 120 receives a superimposed signal, y(t), associated with the modulated conjugated symmetric signals from the set of active terminal devices S_{A}. The network device 120 identifies 214 the set of active terminal devices S_{A} out of the set of terminal devices S based on the received superimposed signal. The conjugate symmetry and sparsity of the modulated conjugated symmetric signals provide the possibility for the network device 120 to identify the active subset S_{A} when multiple active terminal devices 110 asynchronously send UAD signals. In addition, the network device 120 may further estimate 216 the propagation delay related to the set of identified active terminal devices {dₙ}_{n∈S}_{_{A}}, where Ŝ_{A} denotes the set of identified active terminal devices. In this way, a new solution for joint UAD and timing acquisition for massive access with reduced latency and reduced cost of measurement resource is provided. Details of an example identification procedure of the set of active terminal devices S_{A} together with timing acquisition will be described below in detail in connection with FIG. 8.

In some embodiments, the NTB product of the sparse MC-FTN conjugated symmetric signaling may be greater than or equal to twice a ratio of a number of the set of active terminal devices to a number of the set of terminal devices, that is

$$NTB \geq 2 \frac{\vert {S}_{A} \vert}{N}$$

where |S_{A}| denotes the number of terminal devices being active at a given transmission instant or frame. In this way, the NTB product of the sparse MC-FTN conjugated symmetric signaling may be less than one and as small as twice the proportion of active terminal devices, no matter how the total number of devices scales up, thus providing in a scalable scheme for massive access with low measurement cost for joint UAD and optional timing acquisition.

In some embodiments, the subcarrier may be associated exclusively with the terminal device. In this way, the fixed assignment of subcarriers establishes a unique association between preamble sets and terminal devices, which not only avoids the preamble collision due to random assignment, but also saves the additional procedure for reporting the user ID.

In some embodiments, in order to generate the subcarrier, the terminal device 110-1 may generate a complex conjugated symmetric sinusoid waveform with a frequency of the subcarrier. A time duration of the complex conjugated symmetric sinusoid waveform may be determined based on a reciprocal of a subcarrier spacing of the set of subcarriers, the number of the set of active terminal devices, and the number of the set of terminal devices. The terminal device may then add a cyclic prefix to the complex conjugated symmetric sinusoid waveform to generate the subcarrier. In this way, the required time-frequency resource for qualified UAD and timing acquisition may be merely dependent on the proportion of actual active terminal devices and unscalable with the total number of terminal devices N, resulting in a scalable scheme for massive access.

In some embodiments, the terminal device 110-1 may determine a pre-compensation phase factor \hat{Ø}ₙ to the complex conjugated symmetric sinusoid waveform with the cyclic prefix. The pre-compensation phase factor \hat{Ø}ₙ may pre-compensate an UL CPO of a carrier signal of the modulated conjugated symmetric signal caused by a propagation delay from the terminal device to the network device \hat{Ø}ₙ. In this way, the UL CPO in the carrier signal introduced by the propagation delay from the terminal device 110-1 to the network device 120 may be pre-compensated at the terminal device side such that the bias between the pre-compensation phase factor \hat{Ø}ₙ and the UL CPO On, i.e., |\hat{└}ₙ−\hat{Ø}ₙ|, can be controlled within a certain range, which allows for deriving the desirable information of propagation delay from the phase of the symbols received by the network device.

The terminal device 110-1 may determine the pre-compensation phase factor \hat{Ø}ₙ in various manners. The terminal devices 110 may track their DL CPOs, respectively. For one terminal device, its UL CPO caused by a propagation delay from the terminal device to the network device 120 may be the same as its DL CPO caused by a propagation delay from the network device 120 to the terminal device, considering the same propagation delay for the UL-DL pair. In an example implementation, the network device 120 may transmit a beacon signal to the set of terminal devices S indicating transmission of the sparse MC-FTN conjugated symmetric signaling. In order to determine the pre-compensation phase factor \hat{Ø}ₙ, the terminal device 110-1 may determine a DL CPO of the carrier signal based on the received beacon signal and determine the pre-compensation phase factor based on the determined DL CPO.

In some embodiments, the symbol may comprise a variable phase-compensation factor for compensating a phase of a channel between the network device 120 and the terminal device 110-1 in the subcarrier and a fixed phase-compensation factor. In this way, the variable phase compensation factor is adapted to the instantaneous phase of the channel between the network device 120 and the terminal device 110-1 in the subcarrier such that the bias between the variable phase compensation factor and the phase of the channel between the network device 120 and the terminal device 110-1 in the subcarrier can be controlled within a certain range. In conjunction with the pre-compensation phase factor for UL CPO and the variable phase-compensation factor, the fixed phase compensation factor is used to tune the phase of the received symbols in an appropriate range. As such, the phase of received symbols in the subcarriers in a frequency band may contain the solvable and distinguishable information of propagation delay in the radio access network. Taking advantage of the precoding strategies based on phase compensation and conjugated symmetricity as well as the sparse transmission over the frequency domain, the network device 120 can solve the received symbols completely based on the received superimposed signal of the MC-FTN signaling.

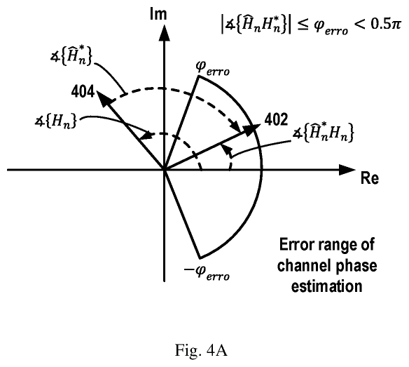

The terminal device 110-1 may determine the variable phase-compensation factor in various manners. In an example implementation, the terminal device 110-1 may determine the variable phase-compensation factor based on the received beacon signal and channel reciprocity between UL and DL. In some embodiments, the terminal device 110-1 may determine the fixed phase-compensation factor based on the frequency of the subcarrier, a frequency of the carrier signal, a bias between the variable phase-compensation factor and the phase of the channel between the network device 120 and the terminal device 110-1 in the subcarrier, and a bias between the pre-compensation phase factor \hat{Ø}ₙ and the UL CPO \hat{Ø}ₙ. In this way, it may facilitate the reconstruction condition for MC-FTN conjugated symmetric signaling on the network device side to be met. Details of an example phase compensation design may be described below in detail in connection with FIGS. 4A-4C.

In some embodiments, the subcarrier may be in a frequency band. A bandwidth of the frequency band may be determined based on a maximum propagation delay in the radio access network, the bias between the variable phase-compensation factor and the phase of the channel between the network device 120 and the terminal device 110-1 in the subcarrier, and the bias between the pre-compensation phase factor \hat{Ø}ₙ and the UL CPO \hat{Ø}ₙ. In other words, the bandwidth of the frequency band, the maximum propagation delay in the radio access network and the fixed phase-compensation factor may be correlated, which enables the reconstruction condition to be met. In some embodiments, the bandwidth of the frequency band for UAD may be limited by a maximum value.

The terminal device 110-1 may generate the modulated conjugated symmetric signal in various manners. In an example implementation, the terminal device 110-1 may generate a discrete-time baseband conjugated symmetric signal based on a baseband frequency of the subcarrier, the variable phase-compensation factor and the fixed phase-compensation factor. The terminal device 110-1 may then generate a continuous-time baseband conjugated symmetric signal based on the discrete-time baseband conjugated symmetric signal, through a digital-to-analogue conversion. The modulated conjugated symmetric signal may be generated by performing frequency shifting for the continuous-time baseband conjugated symmetric signal. Different terminal devices may be discriminated by assigning distinct subcarriers without preamble collision. Based on the introduction of such phase compensation and the conjugated symmetricity, an effective sparse nonzero vector of the received symbols in the distinct subcarriers may preserve the activity information of the corresponding active terminal devices. In the informative vector based on the mixed/superimposed observation, a sign constraint may be applied on the imaginary part of the received symbols. Inactive terminal devices in the network may keep silent and the components corresponding to the inactive terminal devices are zeros. In this manner, the components corresponding to the active terminal devices can be solved from the mixed/superimposed observation.

In some embodiments, the terminal device 110-1 may perform frequency shifting with the pre-compensation phase factor \hat{Ø}ₙ for pre-compensating the UL CPO \hat{Ø}ₙ. By pre-compensating the UL CPO at the terminal device side, the complexity of obtaining the activity information of the corresponding active terminal devices from the mixed/superimposed observation may be reduced.

In some embodiments, in order to generate the discrete-time baseband conjugated symmetric signal, the terminal device 110-1 may generate a first sequence modulated with the variable phase-compensation factor and the fixed phase-compensation factor, by performing an Inverse Discrete Fourier transform (IDFT). A nonzero component of an input of the IDFT may comprise the variable phase-compensation factor and the fixed phase-compensation factor corresponding to the subcarrier. The terminal device 110-1 may then insert a copy of a last portion of the first sequence appended before the first sequence to obtain a second sequence. The inserted last portion of the first sequence may comprise as a cyclic prefix and a conjugated symmetric component. The terminal device 110-1 may then discard a last portion of the second sequence to obtain the discrete-time baseband conjugated symmetric signal. A length of the discrete-time baseband conjugated symmetric signal excluding the cyclic prefix may be determined based on a time duration of the modulated conjugated symmetric signals and a sampling rate. With such definition of length, the qualified UAD and timing acquisition can be made as long as twice the proportion of actual active terminal devices is less than the NTB product, thus minimum measurement cost required for qualified UAD and timing acquisition may be achieved. The designed signaling is a set of non-orthogonal complex conjugated symmetric sinusoid waveforms. Such well-designed waveform and the deliberate phase compensation render the activity detection scheme more efficient and scalable. A MC-FTN conjugated symmetric signaling scheme for accurate, fast and scalable UAD and timing acquisition is thus provided.

In some embodiments, in order to identify the set of active terminal devices S_{A}, the network device 120 may determine a superimposed complex conjugated symmetric sinusoid sequence based on the superimposed signal. The superimposed complex conjugated symmetric sinusoid sequence may comprise symbols received in the set of subcarriers associated with the set of terminal devices S. The network device 120 may determine a superimposed complex sinusoid sequence based on the superimposed complex conjugated symmetric sinusoid sequence and its conjugated symmetricity. The superimposed complex sinusoid sequence may comprise imaginary parts of the received symbols in the subcarriers associated with the set of terminal devices S, and exclude real parts of the received symbols in the set of subcarriers associated with the set of terminal devices S. The network device 120 may then determine a first set of identified active terminal devices based on the superimposed complex sinusoid sequence. Based on the superimposed complex conjugated symmetric sinusoid sequence and the first set of identified active terminal devices, the network device 120 may then determine a second set of identified active terminal devices as the set of identified active terminal devices. In this way, the network device 120 may determine the first set of identified active terminal devices as a coarse estimate of S_{A} from the partial knowledge based on the imaginary parts of the received symbols. The first set is identified out of the set of terminal devices, which involves a large-scale problem based on the dimensionality of the set of terminal devices. The first set may pursue low miss-detection rate with tolerance of large false-alarm rate, which may include almost all active terminal devices and inevitably contain a certain number of inactive terminal devices. Furthermore, the network device 120 may determine the second set of identified active terminal devices as a refined estimate of S_{A} from the full knowledge of the received symbols. The second set is identified by further excluding the inactive terminal devices from the first set, which involves a small-scale problem based on the reduced dimensionality of the first set. As such, the network device 120 may overcome the dimensional deficiency problem through model reduction and determine an accurate estimate of active subset Ŝ_{A} and related information of propagation delay. The careful design of transmission enables such a fast and accurate detection method to derive the activity information from the noisy, asynchronous and superimposed observation even for the MC-FTN signaling.

In some embodiments, in order to determine the first set of identified active terminal devices, the network device 120 may determine, based on the superimposed complex sinusoid sequence, a sparse real vector representing imaginary parts of the received symbols in the set of subcarriers associated with the set of terminal devices. The network device 120 may then determine effective nonzero components of the imaginary parts of the received symbols in the set of subcarriers associated with the set of terminal devices by comparing absolute value of components of the sparse real vector with a first predefined threshold. Based on the effective nonzero components of the imaginary parts of the received symbols in the set of subcarriers associated with the set of terminal devices, the network device 120 may then determine the first set of identified active terminal devices. In this way, the network device 120 may determine a coarse estimate of active subset by deriving the imaginary parts for all terminal devices.

In some embodiments, the network device 120 may determine the sparse real vector by solving an effective Nonnegative Least Square (NLS) problem based on the superimposed complex sinusoid sequence. Components of the sparse real vector corresponding to the imaginary parts of the received symbols in the set of subcarriers with frequencies lower than a carrier frequency may be nonnegative, and components of the sparse real vector corresponding to the imaginary parts of the received symbols in the set of subcarriers with frequencies higher than the carrier frequency may be nonpositive. Such sign constraint on the imaginary parts of the received symbols facilitates solving the sparse real vector from the transformed observations.

In some embodiments, in order to determine the second set of identified active terminal devices, the network device 120 may determine, based on the superimposed complex conjugated symmetric sinusoid sequence, a low-dimensional complex vector representing the received symbols in the set of subcarriers associated with the first set of identified active terminal devices. In some embodiments, the low-dimensional complex vector may be determined under constraints that components of the low-dimensional complex vector corresponding to the imaginary parts of the received symbols in the set of subcarriers with frequencies lower than the carrier frequency are nonnegative, and components of the low-dimensional complex vector corresponding to the imaginary parts of the received symbols in the set of subcarriers with frequencies higher than the carrier frequency are nonpositive. Since imaginary parts of the received symbols in the set of subcarriers associated with the set of terminal devices have been derived and a coarse estimate of active subset have been be determined, the real parts of the received symbols may thus be derived for the coarse active subset by solving a small-scale subproblem after model reduction. The network device 120 may determine effective nonzero components of the received symbols in the set of subcarriers associated with the first set of identified active terminal devices by comparing amplitude of components of the low-dimensional complex vector with a second predefined threshold. The second predefined threshold may be greater than the first predefined threshold for further excluding the inactive terminal device from the first set. The network device 120 may then determine the second set of identified active terminal devices based on the effective nonzero components of the received symbols in the set of subcarriers associated with the first set of identified active terminal devices. In this way, the network device 120 may determine an accurate estimate of active subset Ŝ_{A} by comparing the amplitude of components of the low-dimensional complex vector with a lower threshold value.

In some embodiments, the network device 120 may replace imaginary parts of the received symbol in the set of subcarriers associated the first set of identified active terminal devices with corresponding imaginary parts derived from the sparse real vector. In this way, the accuracy of the estimate of the received symbols may be increased.

In some embodiments, the network device 120 may transmit, to the set of terminal devices S, an indication indicative of a set of identified active terminal devices Ŝ_{A} through a common channel. The terminal device 110-1 may receive the indication from the network device 120 and determine whether it is included in the set of active terminal devices Ŝ_{A} identified by the network device 120. If the terminal device 110-1 is included in the set of active terminal devices Ŝ_{A} identified by the network device 120, the terminal device 110-1 may perform communication with the network device 120. In some embodiments, the indication may be further indicative of resources for performing communication by each of the set of active terminal devices Ŝ_{A} respectively. The terminal device 110-1 may then perform the communication with the network device 120 using respective resource related to the terminal device 110-1. For example, the terminal device 110-1 may further provide further data to the network device 120 using the respective resource indicated for the terminal device 110, for example, for connection-state establishment. If the terminal device 110-1 is excluded from the set of active terminal devices Ŝ_{A} identified by the network device 120, the terminal device 110-1 may retransmit a modulated conjugated symmetric signal to the network device 120.

In some embodiments, the network device 120 may determine propagation delays from the second set of identified active terminal devices Ŝ_{A} to the network device 120 based on phases of the received symbols in the set of subcarriers associated with the second set of identified active terminal devices Ŝ_{A}. In some embodiments, the network device 120 may determine timing advance information related to the second set of identified active terminal devices based on the determined propagation delays from the second set of identified active terminal devices to the network device. The network device 120 may then transmit to the set of terminal devices an indication indicative of the set of identified active terminal devices and the related timing advance information respectively through a common channel. If the terminal device 110-1 is included in the set of active terminal devices Ŝ_{A} identified by the network device 120, the terminal device 110-1 may perform the communication with the network device 120 based on respective timing advance information related to the terminal device 110-1. In this way, synchronous UL transmissions may be enabled.

As a more efficient and effective method, the joint UAD and timing acquisition procedure may be expected to replace PRACH procedure for random access. The network device can quickly know which terminal device has actual demand on data delivery at the beginning of one transmission cycle, and a prompt response may be prepared for a successful communication. In addition, the network device can estimate the propagation delays experienced by the identified terminal devices, thus providing TA information to the identified terminal devices and enabling synchronous UL transmissions.

In some embodiments, the terminal device 110-1 may transmit a data symbol with the variable phase-compensation factor in the subcarrier with the pre-compensation factor for UL CPO. The data symbol may be mapped with traffic data, for example, for small data transmission. In this way, synchronous UL transmissions can be enabled with TA information based on a coarse estimate of propagation delays determined by the network device 120. The coarse estimate may contain the error due to the unknown bias between the pre-compensation phase factor and the UL CPO and/or the unknown bias between the variable phase compensation factor and the phase of the channel between the network device and the terminal device in the subcarrier.

Reference is now made to FIGS. 3A-3B to illustrate example time-domain and frequency-domain structure of signals for conventional data transmission (i.e., data signals) and signals for UAD (i.e., UAD signals) according to some embodiments of the present disclosure, respectively. FIG. 3A illustrates an example diagram of data signals and UAD signals in time domain according to some embodiments of the present disclosure. FIG. 3B illustrates an example diagram of a multiplexing structure of data signals and UAD signals in frequency domain according to some embodiments of the present disclosure. As shown in FIGS. 3A and 3B, the system bandwidth configured for uplink transmission is Bₜₒₜₐₗ Hz.

Data signal and UAD signal are multiplexed in the frequency domain, between which intended Guard Bands (GBs) are inserted to separate them. A continuous B_{UAD}-bandwidth band for UAD 312 is configured and located at central frequency, centered around the carrier frequency f_{c} in Hz. The data signal and UAD signal may use different subcarrier spacings Δf_{D} Hz and Δf_{UAD} Hz, respectively, in the frequency domain and different lengths in time domain. The data signal may comprise a Cyclic Prefix (CP) 304 and a data symbol 302 with a time duration of T_{CP,D} second and T_{syb,D} second, respectively. The UAD signal may comprise a CP 310 and a UAD symbol 306 with a time duration of T_{CP,UAD} second and T_{syb,UAD} second, respectively.

In some embodiments, the data signal may adopt the standard multicarrier design, e.g. Orthogonal Frequency-Division Multiple Access (OFDMA) or Single-carrier Frequency-Division Multiple Access (SC-FDMA) as in the legacy LTE/NR system. The data signal may adopt a wider subcarrier spacing Δf_{D} Hz, and the time duration T_{Syb,D} of the data symbol 304 may be set according to Nyquist rule such that Δf_{D}T_{Syb,D}=1. The data from different terminal devices may be multiplexed across different subset of subcarriers in the bands for data 314 and 316 according to scheduling grants from the network device 120. The time-domain and frequency-domain structure of data signal is illustrative for better understanding of the UAD signal. The present disclosure does not intend to provide any limitation on the design of data signals. Different structures of data signals may be designed.

In some embodiments, the band for UAD 312 may consist of N subcarriers for N terminal devices (i.e., N potential terminal devices) in the network 100 with a narrow and equal subcarrier spacing Δf_{UAD} Hz. A MC-FTN conjugated symmetric signaling is proposed such that Δf_{UAD}T_{syb,UAD}<1. Such MC-FTN conjugated symmetric design results in a shorter UAD symbol less than 1/Δf_{UAD}, reaping the benefits in resource saving and latency reduction. As shown in FIG. 3A, compared with the length of a preamble for PRACH following the Nyquist rule, the length of the UAD symbol 306 is shorten by a time reduction 308. In some embodiments, an intended Guard Time (GT) may be inserted to separate the UAD signal with other signals.

In some embodiments, a fixed association between terminal devices and subcarriers is provided. Each terminal device is assigned with a unique subcarrier so that the network device 120 may identify the active terminal devices by checking which subcarrier components are present in the superimposed signal that the network device receives. The association pattern is preassigned and known for the network device 120 and terminal devices 110, e.g., via an injective mapping between core-network/cell ID and subcarrier index. As a typical example, the terminal device

$$n ∈ S = \{ - \frac{N}{2} , … , - 1 , 1 , … , \frac{N}{2} \}$$

is assigned with an exclusive subcarrier of baseband frequency nΔf_{UAD}, where Direct Current (DC) subcarrier is not utilized in practice usually as it may be subject to disproportionally high interference due to local-oscillator leakage.

In the sparse MC-FTN conjugated symmetric transmission, only the active terminal device

$$n ∈ {S}_{A} ⊆ S = \{ - \frac{N}{2} , … , - 1 , 1 , … , \frac{N}{2} \}$$

sends a symbol

$$\sqrt{{P}_{n}} {e}^{j {φ}_{n}} \frac{{\hat{H}}_{n}^{*}}{‖ {\hat{H}}_{n} ‖}$$

in its associated subcarrier with frequency f_{c}+nΔf_{UAD}, indicated by the subcarriers shown in solid lines in the band for UAD 312, through a sparse MC-FTN conjugated symmetric signaling, where j=\sqrt{−1}, ∥⋅∥ denotes l₂-norm, the superscript (⋅)* denotes conjugation, Pₙ denotes the power factor for the terminal device n, and Ĥₙ denotes the estimate of channel coefficient between the network device and terminal device n in subcarrier f_{c}+nΔf_{UAD}, denoted by Hₙ. That is, the symbol

$$\sqrt{{P}_{n}} {e}^{j {φ}_{n}} \frac{{\hat{H}}_{n}^{*}}{‖ {\hat{H}}_{n} ‖}$$

modulates the associated subcarrier

$${\{ {u}_{n} ( t ) = {e}^{i 2 π ( {f}_{c} + n Δ {f}_{UAD} ) ( t - {T}_{CP , UAD} - 0.5 {T}_{Syb , UAD} )} \}}_{t = 0}^{{T}_{CP , UAD} + {T}_{Syb , UAD}} .$$

The associated subcarrier

$${\{ {u}_{n} ( t ) \}}_{t = 0}^{{T}_{CP , UAD} + {T}_{Syb , UAD}}$$

is produced by generating a complex conjugated symmetric sinusoid waveform

$${\{ {v}_{n} ( t ) = {e}^{i 2 π ( {f}_{c} + n Δ {f}_{UAD} ) ( t - 0.5 {T}_{Syb , UAD} ) )} \}}_{t = 0}^{{T}_{Syb , UAD}}$$

with a frequency of f_{c}+nΔf_{UAD} and with a time duration T_{Syb,UAD}; and adding a cyclic prefix with a time duration T_{CP,UAD} to the complex conjugated symmetric sinusoid waveform. The complex conjugated symmetric sinusoid waveform

$${\{ {v}_{n} ( t ) \}}_{t = 0}^{{T}_{Syb , UAD}} meets {v}_{n} ( - t + 0.5 {T}_{Syb , UAD} ) = {v}_{n}^{*} ( t + 0.5 {T}_{Syb , UAD} )$$

for −0.5T_{Syb,UAD}<t<0.5T_{Syb,UAD}. The time duration T_{Syb,UAD} of the complex conjugated symmetric sinusoid waveform

$${\{ {v}_{n} ( t ) \}}_{t = 0}^{{T}_{Syb , UAD}}$$

may be determined based on a reciprocal of a subcarrier spacing Δf_{UAD}, the number of the set of active terminal devices, i.e., |S_{A}|, and the number of the set of terminal devices, i.e., N, where |⋅| denotes the cardinality of a set. By determining the pre-compensation phase factor \hat{Ø}ₙ in the carrier signal for pre-compensating the UL CPO Øₙ, active terminal device n may transmit a modulated conjugated symmetric signal, which is a RF UAD signal and may be written as Equation (1):

$${s}_{R F , U A D , n} ( t ) = \sqrt{{P}_{n}} {e}^{j {φ}_{n}} \frac{{\hat{H}}_{n}^{*}}{‖ {\hat{H}}_{n} ‖} {e}^{i ( 2 π ( {f}_{c} + n Δ {f}_{UAD} ) ( t - {T}_{CP , UAD} - 0.5 {T}_{Syb , UAD} ) + {\hat{∅}}_{n} )} , 0 \leq t < {T}_{C P , UAD} + {T}_{Syb , UAD} , \qquad ( 1 )$$

The modulated conjugated symmetric signals transmitted by all active terminal devices {S_{RF,UAD,n}(t)}_{n∈S}_{_{A}} comprise the sparse MC-FTN conjugated symmetric signaling.

In some embodiments, the modulated conjugated symmetric signals transmitted by active terminal device n can be described by a baseband signal which is a continuous-time baseband conjugated symmetric signal for user n written as Equation (2):

$${s}_{UAD , n} ( t ) = \sqrt{{p}_{n}} {e}^{j {φ}_{n}} \frac{{\hat{H}}_{n}^{*}}{‖ {\hat{H}}_{n} ‖} {e}^{i 2 π n Δ {f}_{UAD} ( t - {T}_{CP , UAD} - 0.5 {T}_{Syb , UAD} )} , \qquad ( 2 )$$

$$0 \leq t < {T}_{CP , UAD} + {T}_{syb , UAD} ,$$

The adequate size of T_{CP,UAD} is comparable to the sum of propagation delay and spread time of multipath channel for UAD. The symbol

$$\sqrt{{P}_{n}} {e}^{j {φ}_{n}} \frac{{\hat{H}}_{n}^{*}}{‖ {\hat{H}}_{n} ‖}$$

comprises a variable phase-compensation factor

$$∡ \{ {\hat{H}}_{n}^{*} \}$$

for compensating a phase of Hₙ, i.e., ≲{Hₙ}, and a fixed phase-compensation factor φₙ, where ≲{⋅}denotes the angle of a complex number and Hₙ is the Fourier transform of the CIR hₙ(t) at a frequency of f_{c}+nΔf_{UAD} corresponding to the active terminal device n∈S_{A}. Thus, the bias between the variable phase compensation factor and the phase of the channel between the network device and the terminal device n in the subcarrier of f_{c}+nΔf_{UAD} may be written as

$$∡ \{ {\hat{H}}_{n}^{*} {H}_{n} \} . ∡ \{ {\hat{H}}_{n}^{*} {H}_{n} \}$$

is no greater than a maximum error φₑᵣᵣₒ and meets the condition

$$\vert ∡ \{ {\hat{H}}_{n}^{*} {H}_{n} \} \vert + \vert {\hat{∅}}_{n} - {∅}_{n} \vert \leq {φ}_{erro} < 0.5 π .$$

The fixed phase-compensation factor φₙ is designed to cope with the phase-compensation error due to the imperfect variable phase compensation factor for channel phase and/or inaccurate pre-compensation factor for UL CPO, making the phase of the received symbols in an appropriate range and facilitating UAD and timing acquisition.

Reference is now made to FIGS. 4A-4C to illustrate example phase compensation design for UAD signals after performing perfect pre-compensation for UL CPO according to some embodiments of the present disclosure. FIG. 4A illustrates an example diagram of phase-estimation error due to partial priori knowledge on the corresponding UL channel according to some embodiments of the present disclosure. As shown in FIG. 4A, the channel between the network device 120 and the terminal device n in the subcarrier of f_{c}+nΔf_{UAD}, i.e. Hₙ, is represented by the vector 404 in the complex plane. If the phase of the symbol transmitted by the terminal device n is the variable phase-compensation factor

$$∡ \{ {\hat{H}}_{n}^{*} \} ,$$

then the symbol received at the network device 120 can be represented by the vector 402. The variable phase-compensation factor

$$∡ \{ {\hat{H}}_{n}^{*} \}$$

may be determined based on the beacon signal received from the network device 120 and channel reciprocity between UL and DL. In this way, the phase of the received symbol may be equal to the phase-estimation error

$$∡ \{ {\hat{H}}_{n}^{*} {H}_{n} \}$$

which is no greater than the maximum error φₑᵣᵣₒ, i.e.,

$$\vert ∡ \{ {\hat{H}}_{n}^{*} {H}_{n} \} \vert \leq {φ}_{erro} < 0.5 π .$$

To ensure that the phase of the received symbols in the set of subcarriers contains the solvable and distinguishable information of propagation delay, a fixed phase-compensation factor φₙ may be further introduced. FIG. 4B illustrates an example diagram of a phase-compensation factor design according to some embodiments of the present disclosure. FIG. 4C illustrates an example diagram of a reconstruction condition on imaginary part of the received symbols in the set of subcarriers according to some embodiments of the present disclosure. The fixed phase-compensation factor φₙ may be designed to cope with the phase-estimation error

$$∡ \{ {\hat{H}}_{n}^{*} {H}_{n} \} .$$

The fixed phase-compensation factor φₙ may be determined based on the frequency of the subcarrier f_{c}+nΔf_{UAD}, a frequency of the carrier signal f_{c}, a bias

$$∡ \{ {\hat{H}}_{n}^{*} {H}_{n} \}$$

between the variable phase-compensation factor and the phase of the channel in the subcarrier, and a bias between the pre-compensation phase factor \hat{Ø}ₙ and the UL CPO Øₙ. The fixed phase-compensation factor φₙ may be configured based on the partial priori knowledge about the phase-compensation error by Equation (3):

$${φ}_{n} = \{ \begin{matrix}- {φ}_{erro} & n > 0 \\ {φ}_{erro} & n < 0\end{matrix} \qquad ( 3 )$$

As shown in FIG. 4B, for terminal device n associated with a subcarrier with frequencies higher than the carrier frequency, i.e., n>0, after further compensated with the fixed phase-compensation factor φₙ, the symbol of the terminal device n received by the network device 120 is represented by the vector 416, the phase of which is

$$∡ \{ {\hat{H}}_{n}^{*} {H}_{n} \} + {φ}_{n} = ∡ \{ {\hat{H}}_{n}^{*} {H}_{n} \} - {φ}_{erro} \leq 0 .$$

Considering the clockwise phase rotation caused by the round-trip propagation delay, the received symbol turns out to be the vector 418, the phase of which

$$∡ \{ {\hat{H}}_{n}^{*} {H}_{n} \} - {φ}_{erro} - 2 π \frac{n}{{L}_{UAD}} {τ}_{n}$$

where integer

$${L}_{UAD} = \frac{{B}_{total}}{Δ {f}_{UAD}} , {τ}_{n} = \frac{{d}_{n}}{{T}_{s}} \geq 0$$

denotes the round-trip propagation delay of terminal device n in samples,

$${T}_{s} = \frac{1}{{B}_{total}}$$

denotes the corresponding sampling period. If the subcarrier with baseband frequency nΔf_{UAD} is in a frequency band with a feasible bandwidth B_{UAD} such that

$$\vert n \vert Δ {f}_{U A D} \leq \frac{{B}_{UAD}}{2} ,$$

then the phase of the received symbol obeys

$$- π \leq ∡ \{ {\hat{H}}_{n}^{*} {H}_{n} \} - {φ}_{e r r o} - 2 π \frac{n}{{L}_{UAD}} {τ}_{n} \leq 0$$

for any n>0. In other words, the received symbols in the subcarriers higher than the carrier frequency always fall in the lower complex plane, that is, the imaginary parts of those are nonpositive as shown in FIG. 4C. The feasible bandwidth may be smaller than a maximum allowable bandwidth for UAD, which will be described below in detail.

For terminal device n associated with a subcarrier with frequencies lower than the carrier frequency, i.e., n<0, after further compensated with the fixed phase-compensation factor φₙ, the symbol of the terminal device n received by the network device 120 is represented by the vector 426, the phase of which is

$$∡ \{ {\hat{H}}_{n}^{*} {H}_{n} \} + {φ}_{n} = ∡ \{ {\hat{H}}_{n}^{*} {H}_{n} \} + {φ}_{e r r o} \geq 0.$$

Considering the anti-clockwise phase rotation caused by the round-trip propagation delay, the received symbol turns out to be the vector 428, the phase of which

$$∡ \{ {\hat{H}}_{n}^{*} {H}_{n} \} + {φ}_{e r r o} - 2 π \frac{n}{{L}_{UAD}} {τ}_{n} .$$

If the subcarrier with baseband frequency nΔf_{UAD} is in a frequency band with a feasible bandwidth B_{UAD} such that

$$\vert n \vert Δ {f}_{U A D} \leq \frac{{B}_{UAD}}{2} ,$$

then the phase of the received symbol obeys

$$0 \leq ∡ \{ {\hat{H}}_{n}^{*} {H}_{n} \} + {φ}_{e r r o} - 2 π \frac{n}{{L}_{UAD}} {τ}_{n} \leq π$$

for any n<0. In other words, the received symbols in the subcarriers lower than the carrier frequency always fall in the upper complex plane, that is, the imaginary parts of those are nonnegative as shown in FIG. 4C.

As shown in FIGS. 4B and 4C, the deliberate design of phase compensation guarantees that the received symbol in subcarrier with baseband frequency nΔf_{UAD} falls in the lower complex plane for positive n or falls in the upper complex plane for negative n. Considering

$$\vert ∡ \{ {\hat{H}}_{n}^{*} {H}_{n} \} \vert + \vert {\hat{∅}}_{n} - {∅}_{n} \vert \leq {φ}_{e r r o} < 0.5 π ,$$

the phase-compensation error due to inaccurate pre-compensation factor for UL CPO can be also handled in the manner. In this way, a sign constraint on the imaginary parts of the received symbols is constructed and obeys the reconstruction condition that may be formulated as Equation (4):

$$sin ( {\hat{∅}}_{n} - {∅}_{n} + ∡ \{ {\hat{H}}_{n}^{*} {H}_{n} \} + {φ}_{n} - 2 π \frac{n}{{L}_{UAD}} {τ}_{n} ) = \{ \begin{matrix}\leq 0 & n > 0 \\ \geq 0 & n < 0\end{matrix} \qquad ( 4 )$$

In some embodiments, to ensure the above reconstruction condition represented by Equation (4) to be met, the maximum allowable bandwidth for UAD may be determined based on a maximum round-trip propagation delay, denoted by dₘₐₓ second, the bias between the variable phase compensation factor and the phase of the channel between the network device and the terminal device in the subcarrier, i.e.

$$∡ \{ {\hat{H}}_{n}^{*} {H}_{n} \} ,$$

and the bias between the pre-compensation phase factor and the UL CPO, i.e., \hat{Ø}ₙ−Øₙ. Although both biases may be uncertain, they may be limited by the maximum error φₑᵣᵣₒ such that

$$\vert ∡ \{ {\hat{H}}_{n}^{*} {H}_{n} \} \vert + \vert {\hat{∅}}_{n} - {∅}_{n} \vert \leq {φ}_{e r r o} < 0.5 π .$$

In some embodiments, the maximum allowable bandwidth for UAD can be determined as

$$( 1 - \frac{2 {φ}_{erro}}{π} ) \frac{1}{{d}_{max}} ,$$

where dₘₐₓ can be determined based on the coverage of the radio access network, e.g., cell radius for cellular networks. In this way, the feasible bandwidth configuration for MC-FTN conjugated symmetric signaling may be formulated as Equation (5):

$${B}_{UAD} < ( 1 - \frac{2 {φ}_{erro}}{π} ) \frac{1}{{d}_{max}} \qquad ( 5 )$$

In some embodiments, to ensure the qualified UAD and timing acquisition at network device 120, adequate time-frequency resource may be used such that the NTB product at least amounts to twice the proportion of actual active terminal devices, i.e.,

$$2 \frac{\vert {S}_{A} \vert}{N} \leq NTB = Δ {f}_{U A D} {T}_{s y m , U A D} < 1 .$$

In general, the user activity is sparse due to sporadic traffic, which means that

$$\frac{\vert {S}_{A} \vert}{N} ≪ 1$$

always holds and allows for Δf_{UAD}T_{Sym,UAD}<1.

Meanwhile, the inactive terminal devices remain silent in their associated subcarriers, indicated by the subcarriers shown in dotted lines in the band for UAD 312. Considering that the number of inactive terminal devices is much more than the number of active terminal devices, there is a sparse transmission over the frequency domain.

In some embodiments, the UAD signal is generated based on a desirable modulated waveform

$${\{ {s}_{RF , UAD , n} ( t ) \}}_{t = 0}^{{T}_{CP , UAD} + {T}_{Syb , UAD}}$$

for accurate, fast and scalable UAD and timing acquisition, such that the required NTB product Δf_{UAD}T_{Sym,UAD} may be as small as twice the average proportion of active terminal devices,

$$2 \frac{E \{ \vert {S}_{A} \vert \}}{N} ,$$

no matter how the total number of devices, N, scales up, where E{⋅}denotes the mathematical expectation. The waveform

$${\{ {s}_{RF , UAD , n} ( t ) \}}_{t = 0}^{{T}_{CP , UAD} + {T}_{Syb , UAD}}$$

is a complex conjugated symmetric sinusoid signal with constant modulus. Constant modulus is conducive to easing RF transmission for low-cost terminal devices.

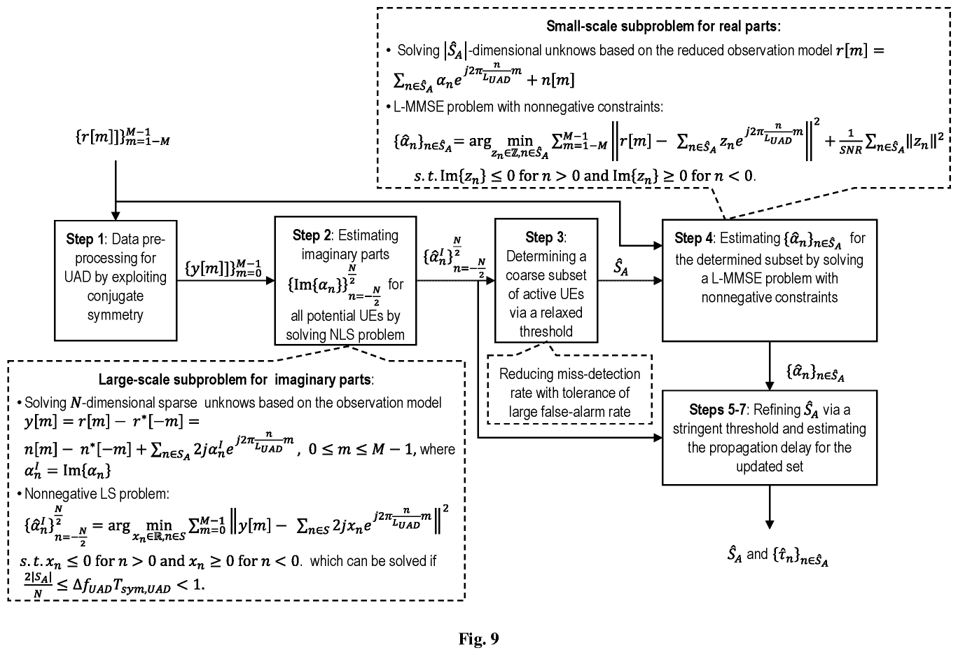

Taking advantage of the intended precoding strategy based on phase compensation and sparsity in transmission, the UAD problem and the estimation problem on the propagation delay may be realized by solving a large-scale subproblem for model reduction and a small-scale subproblem serially. A superimposed complex conjugated symmetric sinusoid sequence preserves the activity information and propagation delay information of the set of active terminal devices. The imaginary parts of the received symbols can be derived for all terminal devices from a mixed observation by the network device 110 by solving a large-scale subproblem based on a superimposed complex sinusoid sequence derived from the superimposed complex conjugated symmetric sinusoid sequence. Based on the derived imaginary parts, a coarse estimate of active subset S_{A} can be determined. Then, the real parts of the received symbols may be derived for the coarse set of terminal devices by solving a small-scale subproblem based on the superimposed complex conjugated symmetric sinusoid sequence after model reduction. Finally, the whole obtained knowledge of the received symbols may be utilized to further refine the estimate of the activity subset S_{A} and estimate the related propagation delays. Details of an example process for joint UAD and timing acquisition algorithm will be described below in detail in connection with FIG. 9.

For the sparse real vector solved from the large-scale subproblem, the components of the sparse real vector corresponding to the imaginary parts of the received symbols in the set of subcarriers with frequencies lower than a carrier frequency may be nonnegative, and components of the sparse real vector corresponding to the imaginary parts of the received symbols in the set of subcarriers with frequencies higher than the carrier frequency may be nonpositive, while the components corresponding to inactive terminal devices are zeros. In essence, the precoding process based on a variable phase-compensation factor

$$∡ \{ {\hat{H}}_{n}^{*} \}$$

and a fixed phase-compensation factor φₙ may be introduced to compensate the phase of UL channels and to pre-compensated the UL CPO in the carrier signal caused by the propagation delay at the terminal device side so that the activity information and propagation delay can be determined by separately deriving the imaginary parts and real parts of the complex vector consisting of the received symbols.

The designed signaling is a set of nonorthogonal complex sinusoid waveforms with conjugated symmetry, with which different terminal devices may be discriminated by assigning distinct subcarriers without preamble collision. An active terminal device may modulate the assigned subcarrier with a phase-compensation factor based on partial priori knowledge about the channel phase and its estimation error. Moreover, a pre-compensation for UL CPO caused by the propagation delay is introduced. The systematic design from fixed association, conjugated symmetry, phase compensation to bandwidth and NTB configuration enables the network device to reconstruct the received symbols in the set of subcarriers. The nonzero/zero value of a received symbol indicates the active/inactive state of its associated terminal device. Furthermore, such a sophisticated design ensures that the phase of the received symbols contains the distinguishable information of propagation delay.

With such well-designed sparse MC-FTN conjugated symmetric signaling, the joint UAD and timing acquisition scheme is more efficient and scalable. Specifically, the holistic design in some embodiments of the present disclosure brings the following advantages:

1) Minimizing measurement cost required for qualified UAD and timing acquisition: Despite the NTB of the MC-FTN conjugated symmetric signaling is Δf_{UAD}T_{sym,UAD}<1, the qualified UAD and timing acquisition may be performed as long as the number of actual active terminal devices is less than

$$\frac{1}{2} N Δ {f}_{UAD} {T}_{sym , UAD} .$$

2) Scalability for massive access: The required time-frequency resource for qualified UAD and timing acquisition is merely dependent on the proportion of actual active terminal devices and unscalable with the total number of terminal devices in the network, resulting in a scalable scheme.

3) Latency reduction: MC-FTN conjugated symmetric signaling allows for a short symbol duration less than the reciprocal of the subcarrier spacing (i.e., T_{sym,UAD}<1/Δf_{UAD}), resulting in a reduction in the unavoidable latency penalty.

4) Facilitating the sparsity detection: The deliberate and systematic design of conjugated symmetry and phase compensation allows the network device to derive the imaginary part of the received symbols just by solving an effective NLS problem. In particular, the sign condition of the imaginary parts introduces the sparsity in a natural way, leading to a fast detection algorithm with finite-step computation.

5) Fixed assignment between preamble and terminal devices establishes a unique association, which not only avoids the preamble collision due to random assignment, but also saves the additional procedure for reporting the user ID.

6) Compatibility to the legacy LTE/NR: Both the transmission and reception procedures are compatible to the multicarrier scheme of LTE/NR, which can be readily integrated with the random access procedure for massive access, serving as a low-cost and high-performance solution.

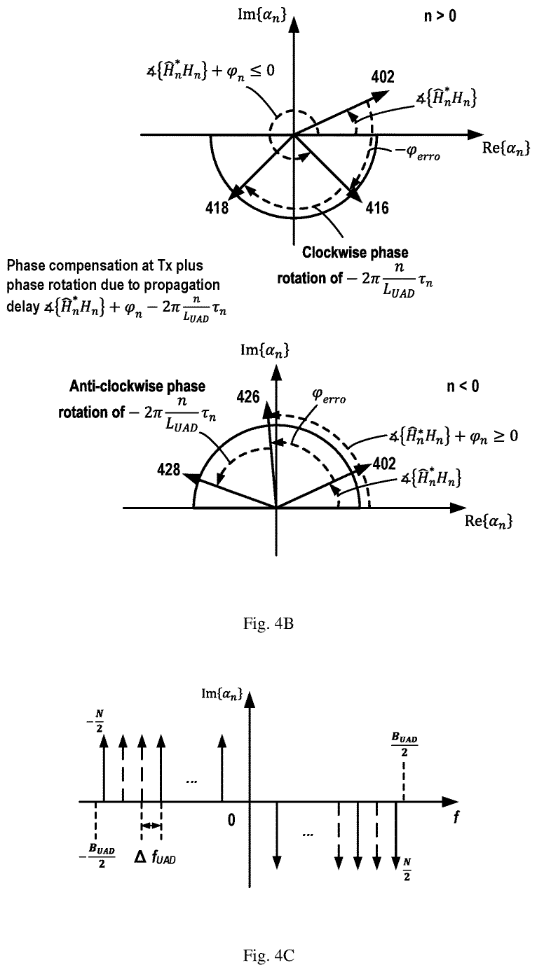

An example transmitter of MC-FTN conjugated symmetric signaling for joint UAD and timing acquisition will be described in terms of waveform design and the related precoding strategy, with reference to FIG. 5, which illustrates an example diagram of a transmission procedure 500 of a modulated conjugated symmetric signal according to some embodiments of the present disclosure. For the purpose of discussion, the transmission procedure of the MC-FTN conjugated symmetric signal will be described from the perspective of the terminal devices 110 with reference to FIG. 1A and the frequency domain structure shown in FIG. 3B.

As shown in FIG. 5, a terminal device

$$n ∈ \{ - \frac{N}{2} , ⋯ , - 1 , 1 , ⋯ , \frac{N}{2} \}$$

may be assigned with an exclusive subcarrier with frequency f_{c}+nΔf_{UAD}. When the terminal device becomes active, a (2M+L_{CP,UAD}−1)-length complex conjugated symmetric sinusoid sequence may be generated according to the associated subcarrier frequency. The complex conjugated symmetric sinusoid sequence may be formulated as Equation (6):

$${\{ {s}_{n} [ m ] = {e}^{j 2 π \frac{n}{{L}_{UAD}} ( m - {L}_{CP , UAD} - M + 1 )} \}}_{m = 0}^{2 M - 2 + {L}_{CP , UAD}} , \qquad ( 6 )$$

where

$${L}_{CP , UAD} = \frac{{T}_{CP , UAD}}{{T}_{s}} and M = \frac{{T}_{Syb , UAD}}{{T}_{s}} .$$

The shift version

$${s}_{n}^{′} [ m ] = {s}_{n} [ m + {L}_{CP , UAD} + M - 1 ]$$

is conjugated symmetric, i.e.,

$${s}_{n}^{′ *} [ m ] = {s}_{n}^{′} [ - m ] for m = 0 , 1 , ⋯ , M - 1.$$

Based on the prior and partial knowledge on the corresponding UL channel, the complex sinusoid sequence sₙ[m] may be modulated with a symbol

$$\sqrt{{P}_{n}} {e}^{{j {φ}_{n}}_{}} \frac{{\hat{H}}_{n}^{*}}{‖ {\hat{H}}_{n} ‖}$$

comprising a variable phase-compensation factor

$$∡ \{ {\hat{H}}_{n}^{*} \}$$

and a fixed phase-compensation factor φₙ via a modulator 502. A discrete-time baseband conjugated symmetric signal S_{UAD,n} [m] may be generated as Equation (7):

$${s}_{UAD , n} [ m ] = \sqrt{{P}_{n}} {e}^{j {φ}_{n}} \frac{{\hat{H}}_{n}^{*}}{‖ {\hat{H}}_{n} ‖} {e}^{j 2 π \frac{n}{{L}_{UAD}} ( m - {L}_{CP , UAD} - M + 1 )} , m = 0 , 1 , ⋯ , , 2 M + {L}_{CP , UAD} - 2 . \qquad ( 7 )$$

The discrete-time baseband conjugated symmetric signal S_{UAD,n}[m] may be converted to a continuous-time baseband conjugated symmetric signal S_{UAD,n}(t) via a digital-to-analog (D/A) convertor 506. The D/A convertor 506 may work with the sampling period Tₛ and ensures S_{UAD,n}[m]=S_{UAD,n}(mTₛ). The continuous-time baseband conjugated symmetric signal S_{UAD,n}(t) may be denoted as Equation (8):

$${s}_{UAD , n} ( t ) = \sqrt{{P}_{n}} {e}^{j {φ}_{n}} \frac{{\hat{H}}_{n}^{*}}{‖ {\hat{H}}_{n} ‖} {e}^{j 2 π n Δ {f}_{UAD} ( t - {T}_{CP , UAD} - 0.5 {T}_{Syb , UAD} )} , 0 \leq t < {T}_{CP , UAD} + {T}_{Syb , UAD} . \qquad ( 8 )$$

A local oscillator of the terminal device generates a carrier signal e^{j}(2πf_{c}(t−T_{CP,UAD}−0.5T_{Syb,UAD})+\hat{Ø}ₙ). The carrier signal contains a pre-compensation phase factor \hat{Ø}ₙ for compensating the corresponding UL CPO of propagation delay −2πf_{c}dₙ in advance such that e^{j}(−2πf_{c}dₙ+\hat{Ø}ₙ)≈1. Based on the carrier signal, the RF module 508 may convert the baseband signal S_{UAD,n}(t) to an RF signal S_{RF,UAD,n}(t), written as Equation (1), for emission.

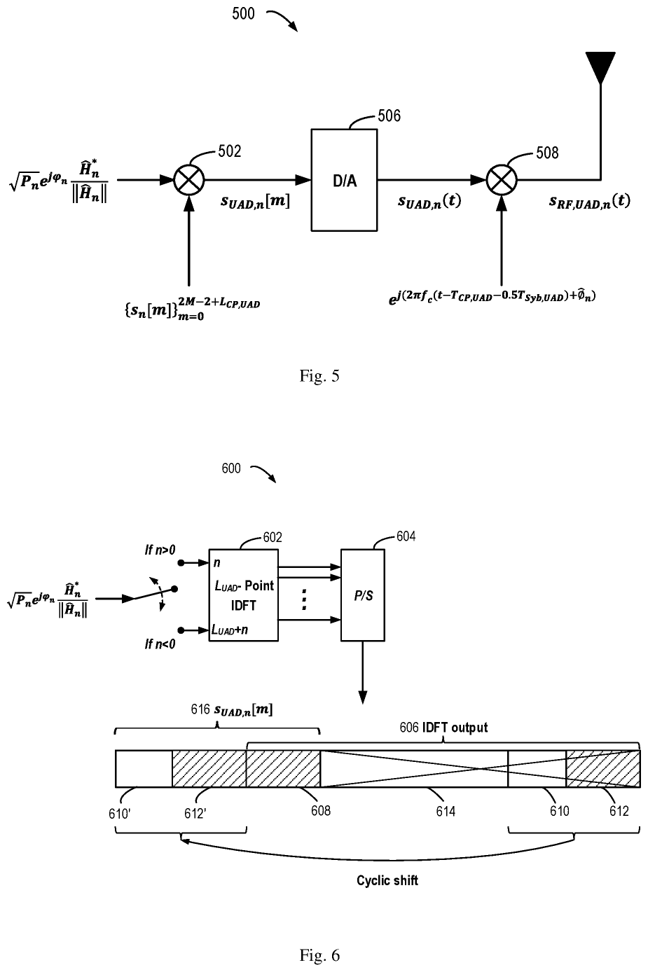

Alternatively, the discrete-time baseband conjugated symmetric signal S_{UAD,n} [m] may be generated through an equivalent IDFT structure. FIG. 6 illustrates an example diagram of a procedure 600 of generating the discrete-time baseband conjugated symmetric signal S_{UAD,n} [m] according to some embodiments of the present disclosure. As shown in FIG. 6, an L_{UAD}-point IDFT 602 is performed with a single nonzero input

$$\sqrt{{P}_{n}} {e}^{j {φ}_{n}} \frac{{\hat{H}}_{n}^{*}}{‖ {\hat{H}}_{n} ‖} .$$

The input index may be determined according to the baseband frequency of the subcarrier associated with the active terminal device

$$n ∈ \{ - \frac{N}{2} , ⋯ , - 1 , 1 , ⋯ , \frac{N}{2} \} ,$$

i.e., nΔf_{UAD}. If n>0, the input index is n. If n<0, the input index is L_{UAD}+n. IDFT 602 may output the L_{UAD}-point samples. A parallel/serial (P/S) conversion 604 may be performed on the L_{UAD}-point samples to obtain the IDFT output 606. The last portion 612 of the IDFT output 506 with a length of M−1 points is copied and appended before the IDFT output 506 as a conjugated symmetric component 612′ through cyclic shift. The second last portion 610 of the IDFT output 506 with a length of L_{CP,UAD} points before the last portion 612 is copied and appended before the (M−1)-point conjugated symmetric component 612′ as a CP 610′ through cyclic shift. The last L_{UAD}−M points of the IDFT output 506 including the last three portions 610, 612 and 614 may be discarded. The CP 610′, the (M−1)-point conjugated symmetric component 612′ and the first M points 608 of the IDFT output 506 may form a (2M+L_{CP,UAD}−1)-length signal of S_{UAD,n}[m] for transmission. The CP 510′ may form the CP symbol 310 and the (M−1)-point conjugated symmetric component 612′ and the first M points 608 may form the UAD symbol 306 of the UAD signal shown in FIG. 3. Obviously, the procedure 600 is compatible to the legacy multicarrier system such as LTE and NR.

In the transmission procedure, no coordination among the terminal devices is needed. Each terminal device behaves independently according to its own scheduling request or traffic demand, the inactive terminal devices refrain from any operations except for keeping silence. The network device 120 has the a priori knowledge on association pattern between the subcarriers and the terminal devices, so that the network device 120 may determine the active terminal devices by detecting which subcarrier components presents in its superimposed observation.

In the transmission procedure 500, when converting the continuous-time baseband conjugated symmetric signal s_{UAD,n}(t) to the RF UAD signal S_{RF,UAD,n}(t), a pre-compensation method is adopted by introducing a pre-compensation phase factor in the carrier signal. As a practical solution, the pre-compensation phase factor \hat{Ø}ₙ can be estimated through a DL beacon signal which is broadcasted from the network device to all potential terminal devices. During the random-access procedure, the DL beacon signal is usually utilized to synchronize the uplink transmissions up to the round-trip propagation delay, estimate the DL channel and exploit the UL/DL reciprocity, and estimate the DL CPO.

FIG. 7A illustrates an example diagram of transmission of DL beacon signal in the communication network 100 according to some embodiments of the present disclosure. FIG. 7B illustrates an example diagram of pre-compensation procedure 700 for UL CPO according to some embodiments of the present disclosure. As shown in FIG. 7A, the network device 120 may broadcast a DL beacon signal to the set of terminal devices S. The DL beacon signal may contain a carrier signal e^{j2πf}^{_{c}}^{t}. The carrier signal e^{j2πf}^{_{c}}^{t} may experience respective DL propagation delays and then arrive at terminal devices asynchronously. In response to receiving the common DL beacon signal, the active terminal device n may be triggered to transmit the RF UAD signal S_{RF,UAD,n}(t) to the network device 120. Thus, the RF UAD signal S_{RF,UAD,n}(t) would experience a round-trip propagation delay, denoted by dₙ, with respect to the starting time. The DL propagation delay of the carrier signal e^{j2πf}^{_{c}}^{t} in the DL beacon signal is half of the round-trip propagation delay. The received carrier signal by the terminal device n may be represented by e^{j(2πf}^{_{c}}^{t-0.5Ø}^{ₙ₎} where \hat{Ø}ₙ=2πf_{c}dₙ.

As shown in FIG. 7B, each terminal device n may use a Phase-Locked Loop (PLL) 702 to estimate the phase of the received carrier signal and obtain an estimate of Øₙ, denoted by \hat{Ø}ₙ, such that e^{j(-2πf}^{_{c}}^{d}^{ₙ}^{+\hat{Ø}}^{ₙ})≈1. Based on the estimated \hat{Ø}ₙ, a local oscillator 704 may produce a carrier signal e^{j(2πf}^{_{c}}^{(t-T}^{_{CP,UAD}}^{-0.5T}^{_{Syb,UAD}})+\hat{Ø}ₙ) that may compensate the UL CPO caused by the corresponding propagation delay do in advance.

With the preamble design of the present disclosure, an accurate, fast, and scalable UAD and timing acquisition at the minimum cost of measurement resource may be constructed. The good signaling design of {S_{RF,UAD,n}(t)}_{n∈S} may facilitate the whole process and promote the detection efficiency and performance. The accurate outcome of UAD may eliminate the uncertainty in the observation model and reduce the problem dimensionality of timing acquisition after model reduction. With some embodiments of the present disclosure, massive capacity, scalability and agility may be achieved. For example, a fixed preamble assignment may be allowed where each terminal device may be pre-assigned with a dedicated sequence beforehand. Instead of random preamble assignment, such a fixed assignment prevents the sequence collision. Any prior coordination in sequence assignment is in vain for random and distributed service requesting. Moreover, the unique association between sequence and users avoids the attached cost for reporting the user ID. The required time-frequency cost may be comparable to the (average) number of active terminal devices and irrelative to the population of massive terminal devices. The sparse MC-FTN conjugated symmetric signaling design enables the NTB product to be comparable to twice the proportion of active terminal devices with

$$NTB \approx 2 \frac{E \{ \vert {S}_{A} \vert \}}{N} \leq 1 .$$

In addition, the sophisticated precoding based on phase compensation transfers the activity information and propagation delay information and allows for accurate and fast user activity detection and timing acquisition at the network device.

An example joint UAD and timing acquisition method based on NLS will be described with reference to FIG. 8, which illustrates an example diagram of a reception procedure 800 of superimposed MC-FTN conjugated symmetric signaling according to some embodiments of the present disclosure. For the purpose of discussion, the reception procedure of the superimposed MC-FTN conjugated symmetric signals will be described from the perspective of the network device 120 with reference to FIG. 1A and the frequency domain structure shown in FIG. 3B.

As shown in FIG. 8, an active terminal device n∈S_{A} may send an exclusive RF UAD signal S_{RF,UAD,n}(t) to the network device 120. The RF UAD signal S_{RF,UAD,n}(t) may experience a round-trip propagation delay dₙ=τₙTₛ and the UL channel hₙ(t). The UL CPOs in terms of −2πf_{c}τₙTₛ are cancelled by the respective pre-compensation phase factor \hat{Ø}ₙ. The network device 120 may receive 802 an asynchronous and superimposed signal g(t). The asynchronous and superimposed RF UAD signals received by the BS may be written as Equation (9):

$$g ( t ) = \{ \begin{matrix}aliasing CP component 1 & 0 \leq t < {T}_{CP , UAD} \\ {e}^{j 2 π {f}_{c} ( t - {T}_{CP , UAD} - 0.5 {T}_{Syb , UAD} )} {\sum }_{n ∈ {S}_{A}} {H}_{n} {s}_{UAD , n} ( t - {τ}_{n} {T}_{s} ) + {n}^{′} ( t ) & {T}_{CP , UAD} \leq t < {T}_{CP , UAD} + {T}_{Syb , UAD}\end{matrix} \qquad ( 9 )$$

where n′(t) stands for the additive disturbance including the thermal noise and the inter-cell interference. The network device 120 is configured to identify the unknown active subset S_{A} and related τₙ based on its observation g(t).

In the reception procedure 800 for the joint UAD and timing acquisition, the network device 120 may perform the standard processing as an OFDM receiver except for Discrete Fourier Transform (DFT) operation. In some embodiments, the network device 120 may convert 804 the received RF UAD signal g(t) to a continuous-time baseband signal z(t) through frequency shift based on a local carrier signal e^{-j2πf}^{_{c}}^{(t-T}^{_{CP,UAD}}^{-0.5T}^{_{syb,UAD}}⁾ generated by a local oscillator 812. The continuous-time baseband signal z(t) may be written as Equation (10):

$$z ( t ) = g ( t ) {e}^{- j 2 π {f}_{c} ( t - {T}_{CP , UAD} - 0.5 {T}_{Syb , UAD} )} = \{ \begin{matrix}aliasing CP component 2 & 0 \leq t < {T}_{CP , UAD} \\ {\sum }_{n ∈ {S}_{A}} {H}_{n} {s}_{UAD , n} ( t - {τ}_{n} {T}_{s} ) + {n}^{″} ( t ) & {T}_{CP , UAD} \leq t < {T}_{CP , UAD} + {T}_{Syb , UAD}\end{matrix} \qquad ( 10 )$$

$$where$$

$${n}^{″} ( t ) = {n}^{′} ( t ) {e}^{- j 2 π {f}_{c} ( t - {T}_{CP , UAD} - 0.5 {T}_{Syb , UAD} )} .$$

The network device 120 may then convert 806 the continuous-time baseband signal z(t) to a (2M−1+L_{CP,UAD})-length discrete-time baseband signal z[m] through A/D convertor that works with sampling period Tₛ. The discrete-time baseband signal z[m] may be written as Equation (11):

$$z [ m ] = z ( {mT}_{s} ) = \{ \begin{matrix}aliasing CP component 3 & m = 0 , 1 , ⋯ , {L}_{CP , UAD} - 1 \\ {\sum }_{n ∈ {S}_{A}} {H}_{n} {s}_{UAD , n} [ m - {τ}_{n} ] + {n}^{″} [ m ] & m = {L}_{CP , UAD} , {L}_{CP , UAD} + 1 , ⋯ , 2 M + {L}_{CP , UAD} - 2\end{matrix} \qquad ( 11 )$$

$$where$$

$${n}^{″} [ m ] = {n}^{″} ( {mT}_{s} ) .$$

The network device 120 may then remove 808 the CP symbols composed of the first L_{CP,UAD}-point of the discrete-time baseband signal z[m], thus obtaining a (2M−1)-length superimposed complex conjugated symmetric sinusoid sequence

$${\{ r [ m ] = z [ m + M + {L}_{CP , UAD} - 1 ] \}}_{m = 1 - M}^{M - 1}$$

for joint UAD and timing acquisition. The (2M−1)-length sequence r[m] may be written as Equation (12):

$$r [ m ] = {\sum }_{n ∈ {S}_{A}} {α}_{n} {e}^{j 2 π \frac{n}{{L}_{UAD}} m} + n [ m ] , m = 1 - M , ⋯ , M - 1 , \qquad ( 12 )$$

where n[m]=nⁿ[m+M+L_{CP,UAD}−1] and

$${α}_{n} = \sqrt{{P}_{n}} {e}^{j {φ}_{n}} \frac{{\hat{H}}_{n}^{*} {H}_{n}}{‖ {\hat{H}}_{n} ‖} {e}^{- j 2 π \frac{n}{{L}_{UAD}} {τ}_{n}}$$

denotes the received symbol in the subcarrier f_{c}+nΔf_{UAD} associated with the terminal device n∈S. In some embodiments where e^{j(-2πf}^{_{c}}^{d}^{ₙ}^{+\hat{Ø}}^{ₙ}⁾ may not approximate to 1 resulting from inaccurate pre-compensation for UL CPO, the received symbol may be written as

$${α}_{n} = \sqrt{{P}_{n}} {e}^{j ( {\hat{∅}}_{n} - {∅}_{n} )} {e}^{j {φ}_{n}} \frac{{\hat{H}}_{n}^{*} {H}_{n}}{‖ {\hat{H}}_{n} ‖} {e}^{- j 2 π \frac{n}{{L}_{UAD}} {τ}_{n}} .$$

Both αₙ and Pₙ share the same indices of nonzero entries induced by the active terminal devices.

The network device 120 may identify S_{A} and the related τₙ based on the (2M−1)-length sequence

$${\{ r [ m ] \}}_{m = 1 - M}^{M - 1}$$

by performing a joint UAD and timing acquisition algorithm 810. The indices of nonzero components in

$${\{ {α}_{n} \}}_{n = - \frac{N}{2}}^{\frac{N}{2}}$$

are identical to those of the active terminal devices. In the algorithm 810, the network device 120 is configured to detect the active terminal devices and estimate their propagation delays by restoring N unknowns

$${\{ {α}_{n} \}}_{n = - \frac{N}{2}}^{\frac{N}{2}}$$

from (2M−1)-length observations

$${\{ r [ m ] \}}_{m = 1 - M}^{M - 1} .$$

The observation model of Equation (12) involves an underdetermined linear system due to the MC-FTN design obeying the rule

$$2 \frac{\vert {S}_{A} \vert}{N} \leq NTB = Δ {f}_{UAD} {T}_{sym , UAD} < 1 .$$

Without loss of generality, considering the case of Bₜₒₜₐₗ=B_{UAD}=NΔf_{UAD}, the length of the observation

$${\{ r [ m ] \}}_{m = 1 - M}^{M - 1} meets 2 M = \frac{{T}_{Syb , UAD}}{{T}_{s}} = {T}_{Syb , UAD} N Δ {f}_{UAD} < N ,$$

meaning an underdetermined linear system with more unknown variables than equations. Although

$${\{ {α}_{n} \}}_{n = - \frac{N}{2}}^{\frac{N}{2}}$$

is sparse with many zero entries, the nonzero components are complex numbers in general, making the solving of the complex vector

$${\{ {α}_{n} \}}_{n = - \frac{N}{2}}^{\frac{N}{2}}$$

from the original received data more challenging.

FIG. 9 illustrates an example implementation of a process for joint UAD and timing acquisition algorithm 810 according to embodiments of the present disclosure. As shown in FIG. 9, at Step 1, the network device may perform data pre-processing for UAD by exploiting conjugated symmetry. The conjugated symmetry designed at the terminal device side enables the network device to remove the real parts of

$${\{ {α}_{n} \}}_{n = - \frac{N}{2}}^{\frac{N}{2}}$$

from the original received data

$${\{ r [ m ] \}}_{m = 1 - M}^{M - 1} ,$$

resulting in a desirable superimposed complex sinusoid sequence

$${\{ y [ m ] \}}_{m = 0}^{M - 1}$$

only depending on the imaginary parts of

$${\{ {α}_{n} \}}_{n = - \frac{N}{2}}^{\frac{N}{2}} .$$

The superimposed complex sinusoid sequence transformed by Step 1 may be represented as Equation (13):

$$y [ m ] = r [ m ] - {r}^{*} [ - m ] = {n}^{*} [ - m ] + {\sum }_{n ∈ {S}_{A}} 2 j {α}_{n}^{I} {e}^{j 2 π \frac{n}{{L}_{UAD}} m} , 0 \leq m \leq M - 1 \qquad ( 13 )$$

where

$${α}_{n}^{I}$$

denotes the imaginary part of αₙ, i.e.,

$${α}_{n}^{I} = \sqrt{{P}_{n}} ‖ {H}_{n} ‖ sin ( ∡ \{ {\hat{H}}_{n}^{*} {H}_{n} \} + {φ}_{n} - 2 π \frac{n}{{L}_{UAD}} {τ}_{n} ) .$$

The deliberate phase compensation strategy for MC-FTN conjugated symmetric signaling at terminal device side results in a sign constraint on the imaginary parts of the received symbols such that the imaginary parts of the unknown vector

$${\{ {α}_{n} \}}_{n = - \frac{N}{2}}^{\frac{N}{2}}$$

is restricted to be nonpositive for positive n or to be nonnegative for negative n, as shown in FIG. 4C. Such sign constraint on

$${α}_{n}^{I}$$

facilitates solving the sparse real vector

$${\{ {α}_{n} \}}_{n = - \frac{N}{2}}^{\frac{N}{2}}$$

from the superimposed complex sinusoid sequence y[m]. The observation model of Equation (13) involves an effective nonnegative underdetermined system. Moreover, the complex sinusoid sequences introduced by subcarrier assignment are vital to capture entire information about the unknown vector

$${\{ {α}_{n} \}}_{n = - \frac{N}{2}}^{\frac{N}{2}}$$

with the minimum time-frequency resource. Such the careful and systematic design enables a fast and accurate detection method for network device 120 to recover

$${\{ {α}_{n} \}}_{n = - \frac{N}{2}}^{\frac{N}{2}}$$

from the noisy observation r[m] in the MC-FTN way.

At Step 2, the sparse real vector

$${\{ {α}_{n} \}}_{n = - \frac{N}{2}}^{\frac{N}{2}}$$

representing the imaginary parts of the received symbols in the set of subcarriers associated with the set of terminal devices in the network are estimated by solving a large-scale subproblem, which can be figured out by exploiting sparsity. For example, an estimate of the sparse real vector

$${\{ {α}_{n} \}}_{n = - \frac{N}{2}}^{\frac{N}{2}}$$

may be derived by solving an effective NLS problem represented as Equation (14):

$${\{ {\hat{α}}_{n}^{I} \}}_{n = - \frac{N}{2}}^{\frac{N}{2}} = arg {min}_{{x}_{n} ∈ ℝ , n ∈ S} {\sum }_{m = 0}^{M - 1} {‖ y [ m ] - {\sum }_{n ∈ S} 2 {jx}_{n} {e}^{j 2 π \frac{n}{{L}_{UAD}} m} ‖}^{2} , \qquad ( 14 )$$

$$s . t . {x}_{n} \leq 0 for n > 0 and {x}_{n} \geq 0 for n < 0.$$

At Step 3, a coarse estimate of active subset is determined as the first set of identified active terminal devices, by determining the effective nonzero components in the estimated sparse real vector

$${\{ {\hat{α}}_{n}^{I} \}}_{n = - \frac{N}{2}}^{\frac{N}{2}}$$

for eliminating the disturbance of observation error. For example, the effective nonzero components can be the components greater than a threshold. In some embodiments, the coarse estimate of active subset can be determined by

$${\hat{S}}_{A} = \{ n ∈ S \vert \vert {\hat{α}}_{n}^{I} \vert \geq {β}_{low} \}$$

where the first predefined threshold β_{low} is assigned with ae small positive number for reducing miss-detection rate with tolerance of large false-alarm rate. In some embodiments, the lower miss-detection rate is pursued, the decision threshold β_{low} may be predefined such that Ŝ_{A} includes almost all active terminal devices. The coarse estimate of S_{A} may be used to enable model reduction for Equation (12) by removing the components corresponding to the inactive terminal devices in accordance with the coarse estimate.

At step 4, a low-dimensional complex vector representing the received symbols in the set of subcarriers associated with the first set of identified active terminal devices, i.e. {αₙ}_{n∈S}_{_{A}}, may be derived by solving a small-scale problem after model reduction. For example, |Ŝ_{A}|-dimensional unknows of {αₙ}_{n∈Ŝ}_{_{A}} may be solved based on a reduced observation model

$$r [ m ] = {\sum }_{n ∈ {\hat{S}}_{A}} {α}_{n} {e}^{j 2 π \frac{n}{{L}_{UAD}} m} + n [ m ]$$

and an estimate of {αₙ}_{n∈ŜA} may be derived by a small-scale Linear Minimum Mean Square Error (L-MMSE) problem under nonnegative constraints as Equation (15)

$${\{ {\hat{α}}_{n} \}}_{n ∈ {\hat{S}}_{A}} = arg {min}_{{z}_{n} ∈ ℤ , n ∈ {\hat{S}}_{A}} {\sum }_{m = 1 - M}^{M - 1} {‖ r [ m ] - {\sum }_{n ∈ {\hat{S}}_{A}} {z}_{n} {e}^{j 2 π \frac{n}{{L}_{UAD}} m} ‖}^{2} + \frac{1}{SNR} {\sum }_{n ∈ {\hat{S}}_{A}} {‖ {z}_{n} ‖}^{2} , \qquad ( 15 )$$

$$s . t . Im \{ {z}_{n} \} \leq 0 for n > 0 and Im \{ {z}_{n} \} \geq 0 for n < 0$$

where Im{⋅}denotes the imaginary part of a complex number and SNR denotes the received Signal-to-Noise Ratio (SNR).

At an optional Step 5, the vectors {\hat{α}ₙ}_{n∈S}_{_{A}} obtained in Step 4 may be updated by replacing its imaginary part with the corresponding imaginary parts in

$${\{ {\hat{α}}_{n}^{I} \}}_{n = - \frac{N}{2}}^{\frac{N}{2}}$$

obtained in Step 2, i.e.,

$${\hat{α}}_{n} = Re \{ {\hat{α}}_{n} \} + j {\hat{α}}_{n}^{I}$$

for n∈Ŝ_{A}, where Re{⋅}represents the real part of a complex number.

At Step 6, the active subset Ŝ_{A} may be refined as the second set of identified active terminal device, by determining the effective nonzero components in the estimated low-dimensional complex vector

$${\{ {\hat{α}}_{n} \}}_{n = - \frac{N}{2}}^{\frac{N}{2}}$$

for eliminating the disturbance of observation error. For example, the effective nonzero components can be the components greater than a threshold. In some embodiments, the active subset Ŝ_{A} may be refined by Ŝ_{A} {n∈Ŝ_{A}∥\hat{α}ₙ|≥β_{high}}, where β_{high}>β_{low}. The second predefined threshold β_{high} is assigned with a larger positive number for reducing false-alarm rate. In scenarios where the lower false-alarm rate is pursued, the decision threshold β_{high} may be increased such that the number of inactive terminal devices in the refined Ŝ_{A} is decreased.

At Step 7, the propagation delay for the terminal devices in the refined active subset Ŝ_{A} may be estimated based on the phase knowledge of {\hat{α}ₙ}_{n∈Ŝ}_{_{A}}, i.e., {≳{\hat{α}ₙ}_{n∈Ŝ}_{_{A}}. In some embodiments, {\hat{τ}ₙ}_{n∈Ŝ}_{_{A}} may be derived as Equation (16):

$${\hat{τ}}_{n} = - \frac{{L}_{UAD}}{2 π n} ( ∡ \{ {\hat{α}}_{n} \} - {φ}_{n} - ∡ \{ {\hat{H}}_{n}^{*} {H}_{n} \} ) , n ∈ {\hat{S}}_{A} . \qquad ( 16 )$$

In some embodiments where an imperfect pre-compensation factor for UL CPO leads to the residual phase of \hat{Ø}ₙ−Øₙ, {\hat{τ}ₙ}_{nEŜ}_{_{A}} may be derived as Equation (17):

$${\hat{τ}}_{n} = - \frac{{L}_{UAD}}{2 π n} ( ∡ \{ {\hat{α}}_{n} \} - {φ}_{n} - ∡ \{ {\hat{H}}_{n}^{*} {H}_{n} \} - ( {\hat{∅}}_{n} - {∅}_{n} ) ) , n ∈ {\hat{S}}_{A} . \qquad ( 17 )$$

In this way, partial knowledge of imaginary part

$${\{ {\hat{α}}_{n}^{I} \}}_{n = - \frac{N}{2}}^{\frac{N}{2}}$$

may be used to derive a coarse estimate of S_{A}, then the whole knowledge of {\hat{α}ₙ}_{nEŜ}_{_{A}} may be used to refine Ŝ_{A} via a stringent threshold for reducing false-alarm rate and to estimate the propagation delay for the updated active subset. In this way, a fast and accurate method for the network device to recover the unknown vector

$${\{ {α}_{n} \}}_{n = - \frac{N}{2}}^{\frac{N}{2}}$$

and obtain propagation delay from the noisy observation r[m] in the MC-FTN manner may be achieved.

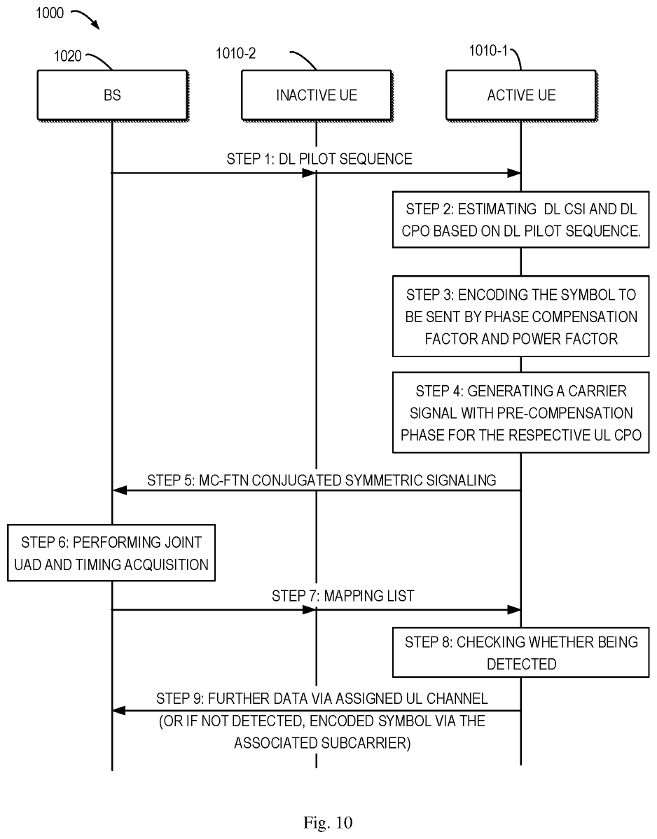

FIG. 10 illustrates an example implementation of a process 1000 for communication according to embodiments of the present disclosure. The process 1000 illustrates a TDD massive random access procedure based on MC-FTN conjugated symmetric signaling, where the UL/DL channel reciprocity can be leveraged to ease phase compensation. It is noted that the process 1000 can be considered as a more specific example of the process 200 of FIG. 2. The example implementation of FIG. 10 is depicted and will be described from perspectives of an active UE 1010-1, an inactive UE 1010-3 and a BS 1020.

At the beginning of a transmission cycle, the BS 1020 may broadcast a DL pilot sequence in the network. The DL pilot sequence may also serve as beacon signal for synchronization. Based on the received DL pilot sequence, the active UE1010-1 may estimate the respective DL Channel State Information (CSI) and DL CPO. The active UE1010-1 may determine the phase compensation factor and power factor based on the estimated DL CSI by exploiting the UL/DL and encode the symbol to be sent with the determined phase compensation factor and power factor. The active UE1010-1 may further predict the UL CPO based on the estimated DL CPO and generate a carrier signal with pre-compensation phase factor for the UL CPO. Based on the carrier signal, the active UE1010-1 may convert the symbol to a MC-FTN conjugated symmetric signaling and transmit the MC-FTN conjugated symmetric signaling to the BS 1020 in an associated subcarrier. The BS 1020 may perform joint UAD and timing acquisition and obtain a set of identified active UEs and the respective TA information based on a superimposed observation. The BS 1020 may broadcast a mapping list indicating the set of identified active UEs through a low-rate DL channel that can be accessed by all UEs in the network. Each row of the mapping list, dedicated to an identified UE, contains the ID of identified UE, the information of related TA and the assigned UL channel. The BS 1020 may assign these resources only for the identified UEs. Table 1 shows an example of information in the mapping list.

TABLE 1
Mapping List

| | | |
|---|---|---|
| ID of detected UE 1 | TA | # UL CH, . . . |
| ID of detected UE 2 | TA | # UL CH, . . . |
| ID of detected UE 3 | TA | # UL CH, . . . |
| . . . | . . . | . . . |

Any UEs can check the mapping list. Through checking, an active UE can determine whether it has been successfully identified by the BS 1020. The identified active UE may know its scheduling grant in the mapping list and may proceed to send further data through the assigned UL channel, for example, for connection-state establishment. Alternatively, the identified active UE n may sends a data symbol encoded by

$$\frac{{\hat{H}}_{n}^{*}}{‖ {\hat{H}}_{n} ‖}$$

in its associated subcarrier with the pre-compensation factor for UL CPO, for conveying a few-bit message. For example, the identified active UE n may transmit a data signal that may be written as

$${s}_{RF , n} ( t ) = \sqrt{{P}_{n}} {b}_{n} \frac{{\hat{H}}_{n}^{*}}{‖ {\hat{H}}_{n} ‖} {e}^{j ( 2 π ( {f}_{c} + n Δ {f}_{UAD} ) ( t - {T}_{CP} ) + {\hat{∅}}_{n} )} ,$$

$$0 \leq t \leq \frac{1}{Δ {f}_{UAD}} ,$$

where T_{CP} is CP length of the data signal and bₙ is the data symbol, e.g., drawn from Quadrature Amplitude Modulation (QAM) constellation. The miss-detected active UE may find nothing related to it in the mapping list and may be relegated to the next transmission cycle for trying a new random access. For example, the miss-detected active UE may issue a new access by retransmitting the MC-FTN conjugated symmetric signaling in the next transmission cycle.

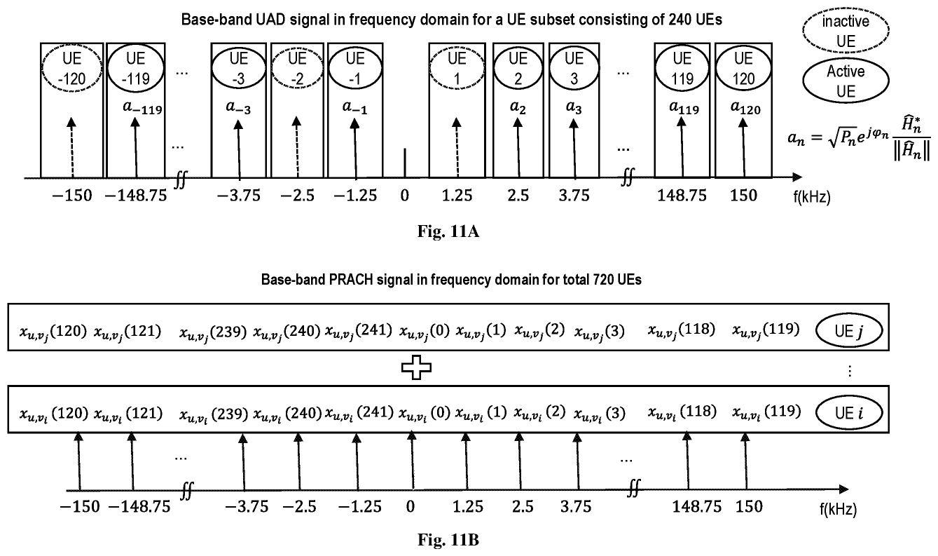

FIG. 11A illustrates an example implementation of MC-FTN conjugated symmetric signaling in frequency domain according to some embodiments of the present disclosure. FIG. 11B illustrates an example diagram of conventional PRACH signals in frequency domain. FIG. 11C illustrates an example diagram of MC-FTN conjugated symmetric signals and conventional PRACH signals in time domain according to some embodiments of the present disclosure. Consider a 500 m-radius cell that serves the total 720 random-access UEs. In this case, the possible maximum round-trip propagation delay amounts to 3.33 μs, then the allowable maximum bandwidth for random access may be 300 kHz. As shown in FIG. 11A, one UAD symbol based on MC-FTN conjugated symmetric signaling may support 240 UEs with subcarrier spacing of 1.25 kHz, each subcarrier is assigned with a unique UE. The NTB product of the MC-FTN conjugated symmetric signaling is 0.25, and thus the symbol duration is reduced to 0.2 ms. Therefore, a resource block of 0.9 ms×300 kHz may fit three independent UAD symbols, as shown in FIG. 11C. The total 720 UEs is divided into 3 subsets, each consisting of 240 UEs and served by a dedicated symbol.

In contrast, the PRACH method supports all UEs by single symbol of 0.8 ms length. According to the design criteria of LTE/NR, the resource block of 0.9 ms×300 kHz allows a 241-length u-th root ZC sequence, i.e.,

$${x}_{u} ( n ) = {e}^{- j π \frac{un ( n + 1 )}{{N}_{ZC}}} ,$$

$$n = 0 , 1 , … , {N}_{ZC} - 1 ,$$

where N_{ZC}=241. The minimum zero-correlation zone of N_{CS}−1=2 accounting for the multipath spread delay and the maximum propagation delay in 500 m-radius cell. Therefore, there are maximum 80 usable orthogonal ZC sequences, i.e., x_{u,v}(n)=xᵤ([n+Cᵥ]N_{ZC}), for v=0,1, . . . , 80, where Cᵥ=v N_{CS}. Each UE spreads its selected sequence over all subcarriers, as shown in FIG. 11B. Active UEs i and j choose sequences x_{u,v}_{ᵢ}(n) and x_{u,v}_{ⱼ}(n) independently out of the same set of 80 orthogonal length-241 ZC sequences, which results in sequence collision if vᵢ=vⱼ.

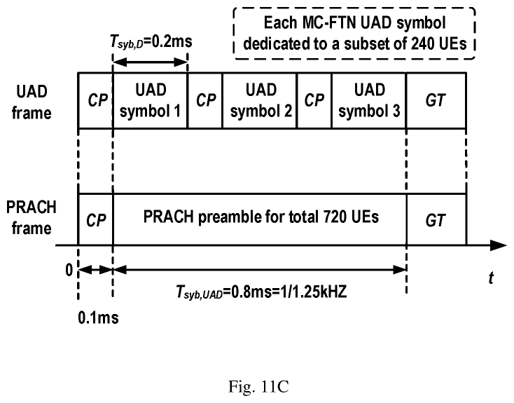

FIGS. 12A and 12B illustrate a joint UAD and timing acquisition performance comparison between MC-FTN conjugated symmetric signaling in accordance with some embodiments of the present disclosure and conventional PRACH procedure via ZC sequence under the same time-frequency resource (0.9 ms×300 kHz). Table 2 lists the detailed simulation parameters of the two procedures.

TABLE 2
Simulation setup

| | MC-FTN | |
|---|---|---|
| | conjugated | |
| | symmetric | |
| PARAMETER | signaling | PRACH via ZC seq. |
| Bₜₒₜₐₗ: total system bandwidth | 30.72 | |
| (MHz) | | |
| Tₛ: Sampling period (μs) | 0.033 | |
| R: Cell radius (m) | 500 | |
| dₘₐₓ: Maximum round-trip | 3.33 | |
| propagation delay (μs) | | |
| Rx SNR after perfect power | 20 and 10 | |
| compensation (dB) | | |
| channel phase compensation | perfect | |
| Uplink carrier phase compensation | perfect | |
| Subcarrier spacing (kHz) | 1.25 | |
| Bandwidth for random access | 300 | |
| (kHz) | | |
| Length of time frame without GT | 0.9 | |
| (ms) | | |
| Total Number of potential UEs | 720 | |
| CP length (ms) | 0.1 | |
| # symbols in a time frame | 3 | 1 |
| symbol duration (ms) | 0.2 | 0.8 |
| Number of total potential UEs for | 240 | 720 |
| each symbol | | |
| NTB: Normalized time-bandwidth | 0.25 | 1 |
| product | | |
| φₑ (rad): Maximum bias of phase | 0 | NA |
| estimation | | |
| N_{ZC}: Length of ZC sequence | NA | 241 |
| N_{CS} − 1: Zero correlation zone of | NA | 2 |
| ZC sequence | | |
| Total number of usable orthogonal | NA | 80 |
| ZC sequences | | |

The UAD performance is evaluated in terms of the probabilities of miss detection and false alarm, while the performance of timing acquisition is evaluated in terms of estimation bias. The simulation results are derived by averaging over 10000 independent experiments. FIG. 12A shows the UAD performance under different transmission probabilities. For the MC-FTN signaling, the threshold of transmission probability is 12.5%, beyond which SNR improvement is diminished significantly and the performance is limited by the degree-of-freedom. Indeed, the threshold coincides with half NTB product of the MC-FTN conjugated symmetric signaling in the simulation case. FIG. 12B shows the performance of timing acquisition with a sampling period of 0.033 μs, where the estimation bias calculates only for the identified UEs. As shown in FIGS. 12A and 12B, long tail for the larger number of identified UEs is found out in higher SNR regime. Simulation results show that the proposed MC-FTN conjugated symmetric signaling can increase the supporting number of concurrent random-access users by above 4 times, compared to the existing PRACH scheme. Such a significant superiority is benefitted from the holistic design from the FTN and collision-free waveform, conjugated symmetry, phase compensation to the advanced algorithm for joint UAD and timing acquisition. For PARCH, in contrast, sequence collision from random selection remains the major cause to performance degradation.

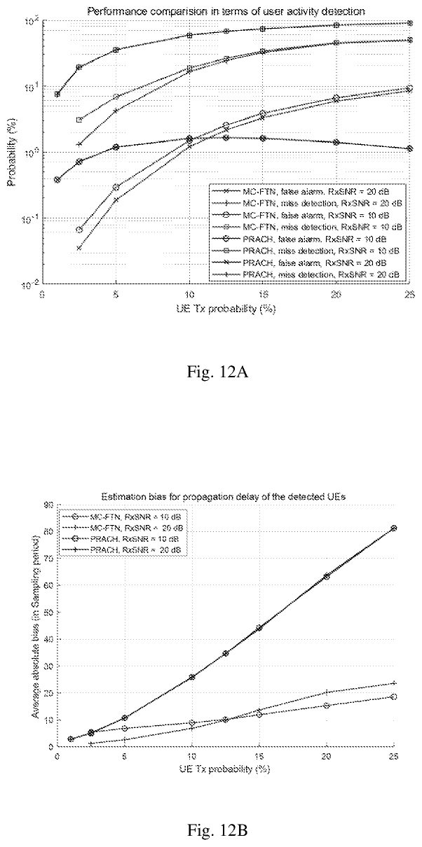

FIG. 13 illustrates a flowchart of a method 1300 implemented at a terminal device according to some embodiments of the present disclosure. For example, the method 1300 may be performed at the terminal device 110 (e.g., first terminal device 110-1) as shown in FIG. 1A. For the purpose of discussion, in the following, the method 1300 will be described with reference to FIG. 1A. It is to be understood that the method 1300 may include additional blocks not shown and/or may omit some blocks as shown, and the scope of the present disclosure is not limited in this regard. With the method 1300 of FIG. 13, a new solution for joint UAD and timing acquisition for massive access with reduced latency and reduced cost of measurement resource is provided.

At block 1320, the terminal device 110 receives, from a network device 120 in the radio access network, a configuration associated with a set of subcarriers, wherein the set of subcarriers are associated with a set of terminal devices in the radio access network for transmission of modulated conjugated symmetric signals. The modulated conjugated symmetric signals are indicative of activity information of a set of active terminal devices out of the set of terminal devices. At block 1340, the terminal device 110 transmits, to the network device 120, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In some embodiments, a normalized time bandwidth product of the sparse MC-FTN conjugated symmetric signaling may be greater than or equal to twice a ratio of a number of the set of active terminal devices to a number of the set of terminal devices. In some embodiments, the subcarrier may be associated exclusively with the terminal device 110.

In some embodiments, in order to generate the subcarrier, the terminal device 110 may generate a complex conjugated symmetric sinusoid waveform with a frequency of the subcarrier and add a cyclic prefix to the complex conjugated symmetric sinusoid waveform.

A time duration of the complex conjugated symmetric sinusoid waveform may be determined based on a reciprocal of a subcarrier spacing of the set of subcarriers, the number of the set of active terminal devices, and the number of the set of terminal devices.

In some embodiments, the terminal device 110 may determine a pre-compensation phase factor to the complex conjugated symmetric sinusoid waveform with the cyclic prefix. The pre-compensation phase factor pre-compensates an UL CPO of a carrier signal of the modulated conjugated symmetric signal caused by a propagation delay from the terminal device 110 to the network device 120.

In some embodiments, in order to determine the pre-compensation phase factor, the terminal device 110 may receive, from the network device 120, a beacon signal comprising the carrier signal; based on the received beacon signal, determine a DL CPO of the carrier signal, caused by a propagation delay from the network device to the terminal device; and determine the pre-compensation phase factor based on the determined DL CPO.

In some embodiments, the symbol may comprise a variable phase-compensation factor for compensating a phase of a channel between the network device 120 and the terminal device 110 in the subcarrier and a fixed phase-compensation factor.

In some embodiments, the terminal device 110 may determine the variable phase-compensation factor based on the beacon signal and channel reciprocity between UL and DL.

In some embodiments, the terminal device 110 may determine the fixed phase-compensation factor based on the frequency of the subcarrier, a frequency of the carrier signal, a bias between the variable phase-compensation factor and the phase of the channel between the network device 120 and the terminal device 110 in the subcarrier, and a bias between the pre-compensation phase factor and the UL CPO.

In some embodiments, the subcarrier may be in a frequency band. A bandwidth of the frequency band may be determined based on a maximum propagation delay in the radio access network, the bias between the variable phase-compensation factor and the phase of the channel between the network device and the terminal device in the subcarrier, and the bias between the pre-compensation phase factor and the UL CPO.

In some embodiments, the terminal device 110 may generate a discrete-time baseband conjugated symmetric signal based on a baseband frequency of the subcarrier, the variable phase-compensation factor and the fixed phase-compensation factor; generate a continuous-time baseband conjugated symmetric signal based on the discrete-time baseband conjugated symmetric signal, through a digital-to-analogue conversion; and perform frequency shifting for the continuous-time baseband conjugated symmetric signal to generate the modulated conjugated symmetric signal.

In some embodiments, in order to generate the discrete-time baseband conjugated symmetric signal, the terminal device 110 may generate a first sequence modulated with the variable phase-compensation factor and the fixed phase-compensation factor, by performing an IDFT; insert a copy of a last portion of the first sequence appended before the first sequence to obtain a second sequence; and discard a last portion of the second sequence to obtain the discrete-time baseband conjugated symmetric signal. A nonzero component of an input of the IDFT may comprise the variable phase-compensation factor and the fixed phase-compensation factor corresponding to the subcarrier. The last portion of the first sequence may comprises a cyclic prefix and a conjugated symmetric component. A length of the discrete-time baseband conjugated symmetric signal excluding the cyclic prefix may be determined based on a time duration of the modulated conjugated symmetric signal and a sampling rate.

In some embodiments, the terminal device 110 may perform frequency shifting with the pre-compensation phase factor for pre-compensating the UL CPO.

In some embodiments, the terminal device 110 may receive, from the network device 120, an indication indicative of a set of active terminal devices identified by the network device 120; determine whether the terminal device 110 is included in the set of active terminal devices identified by the network device 120; and perform communication with the network device 120 based on the determination that the terminal device 110 is included in the set of active terminal devices identified by the network device 120 or retransmit a modulated conjugated symmetric signals to the network device 120 based on the determination that the terminal device 110 is excluded from the set of active terminal devices identified by the network device 120.

In some embodiments, the terminal device 110 may transmit a data symbol with the variable phase-compensation factor in the subcarrier with the pre-compensation factor for UL CPO, the data symbol being mapped with traffic data.

In some embodiments, the indication may be indicative of resources for performing communication by the set of active terminal devices identified by the network device 120 respectively. The terminal device 110 may perform the communication with the network device 120 using respective resource related to the terminal device 110. In some embodiments, the indication may be further indicative of timing advance information related to the set of active terminal devices identified by the network device 120 respectively. The terminal device 110 may perform the communication with the network device 120 based on respective timing advance information related to the terminal device 110.

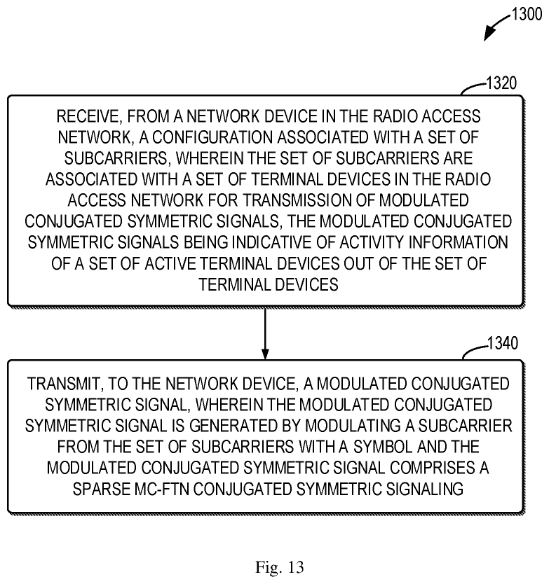

FIG. 14 illustrates a flowchart of a method 1400 implemented at a network device according to some embodiments of the present disclosure. For example, the method 1400 may be performed at the network device 120 as shown in FIG. 1A. For the purpose of discussion, in the following, the method 1400 will be described with reference to FIG. 1A. It is to be understood that the method 1400 may include additional blocks not shown and/or may omit some blocks as shown, and the scope of the present disclosure is not limited in this regard. With the method 1400 of FIG. 14, a new solution for UAD for massive access with reduced latency and reduced cost of measurement resource is provided.

At block 1420, the network device 120 transmits, to a set of terminal devices in the radio access network, a configuration associated with a set of subcarriers. The set of subcarriers are associated with the set of terminal devices for transmission of modulated conjugated symmetric signals. The modulated conjugated symmetric signals are indicative of activity information of the set of active terminal devices out of the set of terminal devices. At block 1440, the network device 120 receives a superimposed signal associated with the modulated conjugated symmetric signals from the set of active terminal devices. The modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling. At block 1440, the network device 120 identifies a set of active terminal devices out of the set of terminal devices based on the received superimposed signal.

In some embodiments, a normalized time bandwidth product of the sparse MC-FTN conjugated symmetric signaling may be greater than or equal to twice a ratio of a number of the set of active terminal devices to a number of the set of terminal devices.

In some embodiments, each of the set of symbols may comprise a variable phase-compensation factor for compensating a phase of a channel between the network device 120 and a corresponding active terminal device in the associated subcarrier and a fixed phase-compensation factor. The fixed phase-compensation factor may be based on a bias between the variable phase-compensation factor and the phase of the channel between the network device 120 and the corresponding active device in the associated subcarrier.

In some embodiments, in order to identify the set of active terminal devices, the network device 120 may determine, based on the superimposed signal, a superimposed complex conjugated symmetric sinusoid sequence which comprises symbols received in the set of subcarriers associated with the set of terminal devices; determine, based on the superimposed complex conjugated symmetric sinusoid sequence and its conjugated symmetricity, a superimposed complex sinusoid sequence which comprises imaginary parts of the received symbols in the subcarriers associated with the set of terminal devices, and excludes real parts of the received symbols in the set of subcarriers associated with the set of terminal devices; determine a first set of identified active terminal devices based on the superimposed complex sinusoid sequence; and determine, based on the superimposed complex conjugated symmetric sinusoid sequence and the first set of identified active terminal devices, a second set of identified active terminal devices as the set of identified active terminal devices.

In some embodiments, in order to determine the first set of identified active terminal devices, the network device 120 may determine, based on the superimposed complex sinusoid sequence, a sparse real vector representing imaginary parts of the received symbols in the set of subcarriers associated with the set of terminal devices; determine effective nonzero components of the imaginary parts of the received symbols in the set of subcarriers associated with the set of terminal devices by comparing absolute value of components of the sparse real vector with a first predefined threshold; and determine the first set of identified active terminal devices based on the effective nonzero components of the imaginary parts of the received symbols in the set of subcarriers associated with the set of terminal devices.

In some embodiments, the network device 120 may determine the sparse real vector by solving an effective nonnegative least square problem based on the superimposed complex sinusoid sequence. Components of the sparse real vector corresponding to the imaginary parts of the received symbols in the set of subcarriers with frequencies lower than a carrier frequency may be nonnegative, and components of the sparse real vector corresponding to the imaginary parts of the received symbols in the set of subcarriers with frequencies higher than the carrier frequency may be nonpositive.

In some embodiments, in order to determine the second set of identified active terminal devices, the network device 120 may determine, based on the superimposed complex conjugated symmetric sinusoid sequence, a low-dimensional complex vector representing the received symbols in the set of subcarriers associated with the first set of identified active terminal devices; determine effective nonzero components of the received symbols in the set of subcarriers associated with the first set of identified active terminal devices by comparing amplitude of components of the low-dimensional complex vector with a second predefined threshold; and determine the second set of identified active terminal devices based on the effective nonzero components of the received symbols in the set of subcarriers associated with the first set of identified active terminal devices.

In some embodiments, the network device 120 may determine the low-dimensional complex vector under constraints that components of the low-dimensional complex vector corresponding to the imaginary parts of the received symbols in the set of subcarriers with frequencies lower than the carrier frequency are nonnegative, and components of the low-dimensional complex vector corresponding to the imaginary parts of the received symbols in the set of subcarriers with frequencies higher than the carrier frequency are nonpositive.

In some embodiments, the network device 120 may replace imaginary parts of the received symbol in the set of subcarriers associated the first set of identified active terminal devices with corresponding imaginary parts derived from the sparse real vector.

In some embodiments, the network device 120 may determine propagation delays from the second set of identified active terminal devices to the network device 120 based on phases of the received symbol in the set of subcarriers associated with the second set of identified active terminal devices.

In some embodiments, the network device 120 may determine timing advance information related to the second set of identified active terminal devices based on the determined propagation delays from the second set of identified active terminal devices to the network device 120; and transmit to the set of terminal devices an indication indicative of the set of identified active terminal devices and the related timing advance information respectively through a common channel.

In some embodiments, the indication may be indicative of resources for performing communication by each of the set of identified active terminal devices respectively.

In some embodiments, the network device 120 may transmit a beacon signal to the set of terminal devices indicating transmission of the sparse MC-FTN conjugated symmetric signaling.

In some embodiments, an apparatus capable of performing any of the method 1300 (for example, the terminal device 110) may comprise means for performing the respective steps of the method 1300. The means may be implemented in any suitable form. For example, the means may be implemented in a circuitry or software module.

In some embodiments, the apparatus comprises: means for receiving, at a terminal device from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and means for transmitting, to the network device, a modulated conjugated symmetric signal, wherein the modulated conjugated symmetric signal is generated by modulating a subcarrier from the set of subcarriers with a symbol and the modulated conjugated symmetric signal comprises a sparse MC-FTN conjugated symmetric signaling.

In some embodiments, a normalized time bandwidth product of the sparse MC-FTN conjugated symmetric signaling may be greater than or equal to twice a ratio of a number of the set of active terminal devices to a number of the set of terminal devices. In some embodiments, the subcarrier may be associated exclusively with the terminal device.

In some embodiments, the means for generating the subcarrier may comprise means for generating a complex conjugated symmetric sinusoid waveform with a frequency of the subcarrier and means for adding a cyclic prefix to the complex conjugated symmetric sinusoid waveform. A time duration of the complex conjugated symmetric sinusoid waveform may be determined based on a reciprocal of a subcarrier spacing of the set of subcarriers, the number of the set of active terminal devices, and the number of the set of terminal devices.

In some embodiments, the apparatus may further comprise means for determining a pre-compensation phase factor to the complex conjugated symmetric sinusoid waveform with the cyclic prefix, wherein the pre-compensation phase factor pre-compensates an UL CPO of a carrier signal of the modulated conjugated symmetric signal caused by a propagation delay from the terminal device to the network device.

In some embodiments, the means for determining the pre-compensation phase factor may comprise means for receiving, from the network device, a beacon signal comprising the carrier signal; means for determining a DL CPO of the carrier signal, caused by a propagation delay from the network device to the terminal device, based on the received beacon signal; and means for determining the pre-compensation phase factor based on the determined DL CPO.

In some embodiments, the symbol may comprise a variable phase-compensation factor for compensating a phase of a channel between the network device and the terminal device in the subcarrier and a fixed phase-compensation factor.

In some embodiments, the apparatus may further comprise means for determining the variable phase-compensation factor based on the beacon signal and channel reciprocity between UL and DL.

In some embodiments, the apparatus may further comprise means for determining the fixed phase-compensation factor based on the frequency of the subcarrier, a frequency of the carrier signal, a bias between the variable phase-compensation factor and the phase of the channel between the network device and the terminal device in the subcarrier, and a bias between the pre-compensation phase factor and the UL CPO.

In some embodiments, the subcarrier may be in a frequency band. A bandwidth of the frequency band may be determined based on a maximum propagation delay in the radio access network, the bias between the variable phase-compensation factor and the phase of the channel between the network device and the terminal device in the subcarrier, and the bias between the pre-compensation phase factor and the UL CPO.

In some embodiments, the apparatus may further comprise means for generating a discrete-time baseband conjugated symmetric signal based on a baseband frequency of the subcarrier, the variable phase-compensation factor and the fixed phase-compensation factor; means for generating a continuous-time baseband conjugated symmetric signal based on the discrete-time baseband conjugated symmetric signal, through a digital-to-analogue conversion; and means for performing frequency shifting for the continuous-time baseband conjugated symmetric signal to generate the modulated conjugated symmetric signal.

In some embodiments, the means for generating the discrete-time baseband conjugated symmetric signal may comprise means for generating a first sequence modulated with the variable phase-compensation factor and the fixed phase-compensation factor, by performing an IDFT; means for inserting a copy of a last portion of the first sequence appended before the first sequence to obtain a second sequence; and means for discarding a last portion of the second sequence to obtain the discrete-time baseband conjugated symmetric signal. A nonzero component of an input of the IDFT may comprise the variable phase-compensation factor and the fixed phase-compensation factor corresponding to the subcarrier. The last portion of the first sequence may comprise a cyclic prefix and a conjugated symmetric component. A length of the discrete-time baseband conjugated symmetric signal excluding the cyclic prefix may be determined based on a time duration of the modulated conjugated symmetric signal and a sampling rate.

In some embodiments, the apparatus may further comprise means for performing frequency shifting with the pre-compensation phase factor for pre-compensating the UL CPO.

In some embodiments, the apparatus may further comprise means for receiving, from the network device, an indication indicative of a set of active terminal devices identified by the network device; means for determining whether the terminal device is included in the set of active terminal devices identified by the network device; and means for performing communication with the network device based on the determination that the terminal device is included in the set of active terminal devices identified by the network device or retransmitting a modulated conjugated symmetric signal to the network device based on the determination that the terminal device is excluded from the set of active terminal devices identified by the network device.

In some embodiments, the apparatus may further comprise means for transmitting a data symbol with the variable phase-compensation factor in the subcarrier with the pre-compensation factor for UL CPO, the data symbol being mapped with traffic data.

In some embodiments, the indication may be indicative of resources for performing communication by the set of active terminal devices identified by the network device respectively. The apparatus may further comprise means for performing the communication with the network device using respective resource related to the terminal device.

In some embodiments, the indication may be indicative of timing advance information related to the set of active terminal devices identified by the network device respectively. The apparatus may further comprise means for performing the communication with the network device based on respective timing advance information related to the terminal device.

In some embodiments, the apparatus further comprises means for performing other steps in some embodiments of the method 1300. In some embodiments, the means comprises at least one processor and at least one memory including computer program code, the at least one memory and computer program code configured to, with the at least one processor, cause the performance of the apparatus.

In some embodiments, an apparatus capable of performing any of the method 1400 (for example, the network device 120) may comprise means for performing the respective steps of the method 1400. The means may be implemented in any suitable form. For example, the means may be implemented in a circuitry or software module.

In some embodiments, the apparatus comprises: means for transmitting, at a network device to a set of terminal devices in a radio access network, a configuration associated with a set of subcarriers, wherein the set of subcarriers are associated with the set of terminal devices for transmission of modulated conjugated symmetric signals, the modulated conjugated symmetric signals being indicative of activity information of a set of active terminal devices out of the set of terminal devices; means for receiving a superimposed signal associated with the modulated conjugated symmetric signals from the set of active terminal devices, wherein the modulated conjugated symmetric signals are generated by modulating the set of subcarriers associated with the set of active terminal devices with a set of symbols corresponding to the set of active terminal devices, respectively, and comprise a sparse MC-FTN conjugated symmetric signaling; and means for identifying the set of active terminal devices out of the set of terminal devices based on the received superimposed signal.

In some embodiments, a normalized time bandwidth product of the sparse MC-FTN conjugated symmetric signaling may be greater than or equal to twice a ratio of a number of the set of active terminal devices to a number of the set of terminal devices.

In some embodiments, each of the set of symbols may comprise a variable phase-compensation factor for compensating a phase of a channel between the network device and a corresponding active terminal device in the associated subcarrier and a fixed phase-compensation factor. The fixed phase-compensation factor may be based on a bias between the variable phase-compensation factor and the phase of the channel between the network device and the corresponding active device in the associated subcarrier.

In some embodiments, the means for identifying the set of active terminal devices may comprise means for determining, based on the superimposed signal, a superimposed complex conjugated symmetric sinusoid sequence which comprises symbols received in the set of subcarriers associated with the set of terminal devices; means for determining, based on the superimposed complex conjugated symmetric sinusoid sequence and its conjugated symmetricity, a superimposed complex sinusoid sequence which comprises imaginary parts of the received symbols in the subcarriers associated with the set of terminal devices, and excludes real parts of the received symbols in the set of subcarriers associated with the set of terminal devices; means for determining a first set of identified active terminal devices based on the superimposed complex sinusoid sequence; and means for determining, based on the superimposed complex conjugated symmetric sinusoid sequence and the first set of identified active terminal devices, a second set of identified active terminal devices as the set of identified active terminal devices.

In some embodiments, the means for determining the first set of identified active terminal devices may comprise means for determining, based on the superimposed complex sinusoid sequence, a sparse real vector representing imaginary parts of the received symbols in the set of subcarriers associated with the set of terminal devices; means for determining effective nonzero components of the imaginary parts of the received symbols in the set of subcarriers associated with the set of terminal devices by comparing absolute value of components of the sparse real vector with a first predefined threshold; and means for determining the first set of identified active terminal devices based on the effective nonzero components of the imaginary parts of the received symbols in the set of subcarriers associated with the set of terminal devices.

In some embodiments, the apparatus may further comprise means for determining the sparse real vector by solving an effective nonnegative least square problem based on the superimposed complex sinusoid sequence. Components of the sparse real vector corresponding to the imaginary parts of the received symbols in the set of subcarriers with frequencies lower than a carrier frequency may be nonnegative, and components of the sparse real vector corresponding to the imaginary parts of the received symbols in the set of subcarriers with frequencies higher than the carrier frequency may be nonpositive.

In some embodiments, the means for determining the second set of identified active terminal devices may comprise means for determining, based on the superimposed complex conjugated symmetric sinusoid sequence, a low-dimensional complex vector representing the received symbols in the set of subcarriers associated with the first set of identified active terminal devices; means for determining effective nonzero components of the received symbols in the set of subcarriers associated with the first set of identified active terminal devices by comparing amplitude of components of the low-dimensional complex vector with a second predefined threshold; and means for determining the second set of identified active terminal devices based on the effective nonzero components of the received symbols in the set of subcarriers associated with the first set of identified active terminal devices.

In some embodiments, the apparatus may further comprise means for determining the low-dimensional complex vector under constraints that components of the low-dimensional complex vector corresponding to the imaginary parts of the received symbols in the set of subcarriers with frequencies lower than the carrier frequency are nonnegative, and components of the low-dimensional complex vector corresponding to the imaginary parts of the received symbols in the set of subcarriers with frequencies higher than the carrier frequency are nonpositive.

In some embodiments, the apparatus may further comprise means for replacing imaginary parts of the received symbol in the set of subcarriers associated the first set of identified active terminal devices with corresponding imaginary parts derived from the sparse real vector.

In some embodiments, the apparatus may further comprise means for determining propagation delays from the second set of identified active terminal devices to the network device based on phases of the received symbol in the set of subcarriers associated with the second set of identified active terminal devices.

In some embodiments, the apparatus may further comprise means for determining timing advance information related to the second set of identified active terminal devices based on the determined propagation delays from the second set of identified active terminal devices to the network device; and means for transmitting to the set of terminal devices an indication indicative of the set of identified active terminal devices and the related timing advance information respectively through a common channel.

In some embodiments, the indication may be indicative of resources for performing communication by each of the set of identified active terminal devices respectively.

In some embodiments, the apparatus may further comprise means for transmitting a beacon signal to the set of terminal devices indicating transmission of the sparse MC-FTN conjugated symmetric signaling.

In some embodiments, the apparatus further comprises means for performing other steps in some embodiments of the method 1400. In some embodiments, the means comprises at least one processor and at least one memory including computer program code, the at least one memory and computer program code configured to, with the at least one processor, cause the performance of the apparatus.

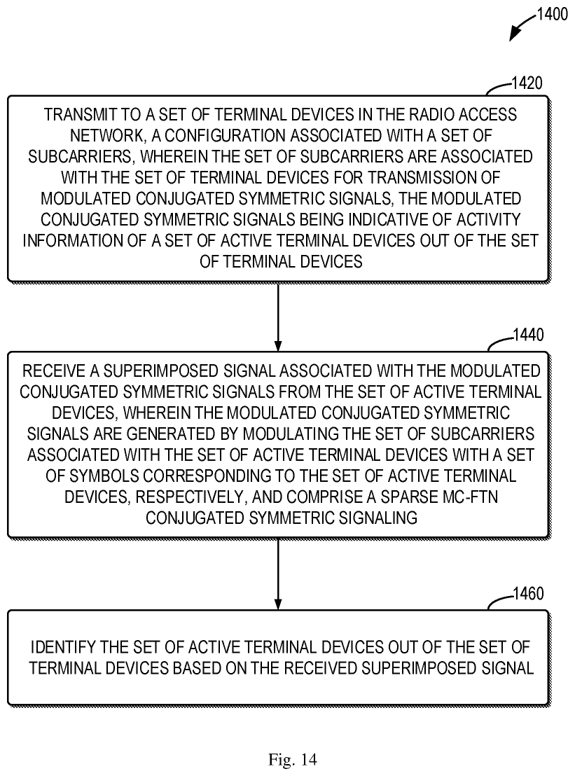

FIG. 15 is a simplified block diagram of a device 1500 that is suitable for implementing embodiments of the present disclosure. The device 1500 may be provided to implement the communication device, for example the terminal device 110, or the network device 120 as shown in FIG. 1A. As shown, the device 1500 includes one or more processors 1510, one or more memories 1540 coupled to the processor 1510, and one or more communication modules 1540 coupled to the processor 1510.

The communication module 1540 is for bidirectional communications. The communication module 1540 has at least one antenna to facilitate communication. The communication interface may represent any interface that is necessary for communication with other network elements.

The processor 1510 may be of any type suitable to the local technical network and may include one or more of the following: general purpose computers, special purpose computers, microprocessors, Digital Signal Processors (DSPs) and processors based on multicore processor architecture, as non-limiting examples. The device 1500 may have multiple processors, such as an application specific integrated circuit chip that is slaved in time to a clock which synchronizes the main processor.

The memory 1520 may include one or more non-volatile memories and one or more volatile memories. Examples of the non-volatile memories include, but are not limited to, a Read Only Memory (ROM) 1524, an Electrically Programmable Read Only Memory (EPROM), a flash memory, a hard disk, a Compact Disc (CD), a Digital Video Disk (DVD), and other magnetic storage and/or optical storage. Examples of the volatile memories include, but are not limited to, a Random Access Memory (RAM) 1522 and other volatile memories that will not last in the power-down duration.

A computer program 1530 includes computer executable instructions that are executed by the associated processor 1510. The program 1530 may be stored in the ROM 1524. The processor 1510 may perform any suitable actions and processing by loading the program 1530 into the RAM 1522.

The embodiments of the present disclosure may be implemented by means of the program 1530 so that the device 1500 may perform any process of the disclosure as discussed with reference to FIGS. 1A-13. The embodiments of the present disclosure may also be implemented by hardware or by a combination of software and hardware.

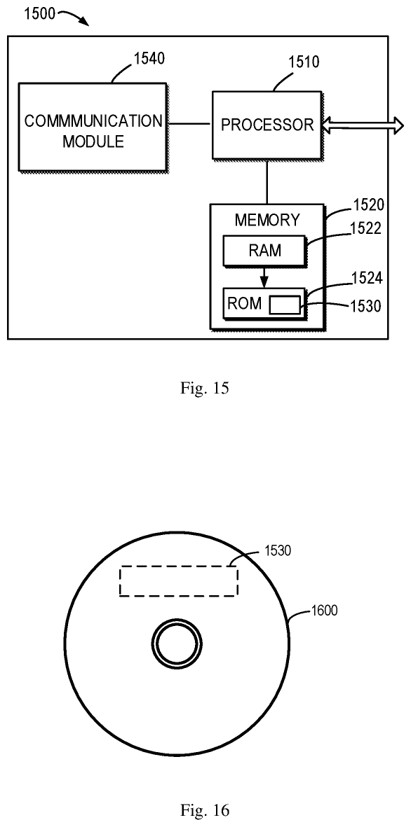

In some embodiments, the program 1530 may be tangibly contained in a computer readable medium which may be included in the device 1500 (such as in the memory 1520) or other storage devices that are accessible by the device 1500. The device 1500 may load the program 1530 from the computer readable medium to the RAM 1522 for execution. The computer readable medium may include any types of tangible non-volatile storage, such as ROM, EPROM, a flash memory, a hard disk, CD, DVD, and the like. FIG. 16 shows an example of the computer readable medium 1600 in form of CD or DVD. The computer readable medium has the program 1530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1300 or 1400 as described above with reference to FIGS. 1A-14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a Random Access Memory (RAM), a Read-Only Memory (ROM), an Erasable Programmable Read-Only Memory (EPROM or Flash memory), an optical fiber, a portable Compact Disc Read-Only Memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-35. (canceled)

36. A terminal device in a radio access network comprising:
at least one processor; and
at least one memory storing instructions that, when executed by the at least one processor, cause the terminal device at least to:
receive, from a network device in the radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and
transmit, to the network device, a modulated conjugated symmetric signal, wherein the modulated conjugated symmetric signal is generated by modulating a subcarrier from the set of subcarriers with a symbol and the modulated conjugated symmetric signal comprises a sparse Multicarrier Faster Than Nyquist (MC-FTN) conjugated symmetric signaling.

37. The terminal device of claim 36, wherein a normalized time bandwidth product of the sparse MC-FTN conjugated symmetric signaling is greater than or equal to twice a ratio of a number of the set of active terminal devices to a number of the set of terminal devices.

38. The terminal device of claim 36, wherein the subcarrier is associated exclusively with the terminal device.

39. The terminal device of claim 36, wherein the terminal device is caused to generate the subcarrier by:
generating a complex conjugated symmetric sinusoid waveform with a frequency of the subcarrier, wherein a time duration of the complex conjugated symmetric sinusoid waveform is determined based on a reciprocal of a subcarrier spacing of the set of subcarriers, the number of the set of active terminal devices, and the number of the set of terminal devices; and
adding a cyclic prefix to the complex conjugated symmetric sinusoid waveform.

40. The terminal device of claim 39, wherein the terminal device is further caused to determine a pre-compensation phase factor to the complex conjugated symmetric sinusoid waveform with the cyclic prefix, wherein the pre-compensation phase factor pre-compensates an Uplink Carrier Phase Offset (UL CPO) of a carrier signal of the modulated conjugated symmetric signal caused by a propagation delay from the terminal device to the network device.

41. The terminal device of claim 40, wherein the terminal device is further caused to determine the pre-compensation phase factor by:
receiving, from the network device, a beacon signal comprising the carrier signal;
based on the received beacon signal, determining a Downlink Carrier Phase Offset (DL CPO) of the carrier signal, caused by a propagation delay from the network device to the terminal device; and
determining the pre-compensation phase factor based on the determined DL CPO.

42. The terminal device of claim 41, wherein the symbol comprises a variable phase-compensation factor for compensating a phase of a channel between the network device and the terminal device in the subcarrier and a fixed phase-compensation factor.

43. The terminal device of claim 42, wherein the terminal device is further caused to determine the variable phase-compensation factor based on the beacon signal and channel reciprocity between UL and DL.

44. A method comprising:
receiving, at a terminal device from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and
transmitting, to the network device, a modulated conjugated symmetric signal, wherein the modulated conjugated symmetric signal is generated by modulating a subcarrier from the set of subcarriers with a symbol and the modulated conjugated symmetric signal comprises a sparse Multicarrier Faster Than Nyquist (MC-FTN) conjugated symmetric signaling.

45. The method of claim 44, wherein a normalized time bandwidth product of the sparse MC-FTN conjugated symmetric signaling is greater than or equal to twice a ratio of a number of the set of active terminal devices to a number of the set of terminal devices.

46. The method of claim 44, wherein the subcarrier is associated exclusively with the terminal device.

47. The method of claim 44, wherein the terminal device is caused to generate the subcarrier by:
generating a complex conjugated symmetric sinusoid waveform with a frequency of the subcarrier, wherein a time duration of the complex conjugated symmetric sinusoid waveform is determined based on a reciprocal of a subcarrier spacing of the set of subcarriers, the number of the set of active terminal devices, and the number of the set of terminal devices; and
adding a cyclic prefix to the complex conjugated symmetric sinusoid waveform.

48. The method of claim 47, wherein the terminal device is further caused to determine a pre-compensation phase factor to the complex conjugated symmetric sinusoid waveform with the cyclic prefix, wherein the pre-compensation phase factor pre-compensates an Uplink Carrier Phase Offset (UL CPO) of a carrier signal of the modulated conjugated symmetric signal caused by a propagation delay from the terminal device to the network device.

49. The method of claim 48, wherein the terminal device is further caused to determine the pre-compensation phase factor by:
receiving, from the network device, a beacon signal comprising the carrier signal;
based on the received beacon signal, determining a Downlink Carrier Phase Offset (DL CPO) of the carrier signal, caused by a propagation delay from the network device to the terminal device; and
determining the pre-compensation phase factor based on the determined DL CPO.

50. The method of claim 49, wherein the symbol comprises a variable phase-compensation factor for compensating a phase of a channel between the network device and the terminal device in the subcarrier and a fixed phase-compensation factor.

51. The method of claim 50, wherein the terminal device is further caused to determine the variable phase-compensation factor based on the beacon signal and channel reciprocity between UL and DL.

52. A non-transitory computer readable medium comprising program instructions that, when executed by an apparatus, cause the apparatus to perform at least:
receiving, at the apparatus from a network device in a radio access network, a configuration associated with a set of subcarriers, wherein the set of subcarriers are associated with a set of terminal devices in the radio access network for transmission of modulated conjugated symmetric signals, the modulated conjugated symmetric signals being indicative of activity information of a set of active terminal devices out of the set of terminal devices; and
transmitting, to the network device, a modulated conjugated symmetric signal, wherein the modulated conjugated symmetric signal is generated by modulating a subcarrier from the set of subcarriers with a symbol and the modulated conjugated symmetric signal comprises a sparse Multicarrier Faster Than Nyquist (MC-FTN) conjugated symmetric signaling.

53. The non-transitory computer readable medium of claim 52, wherein a normalized time bandwidth product of the sparse MC-FTN conjugated symmetric signaling is greater than or equal to twice a ratio of a number of the set of active terminal devices to a number of the set of terminal devices.

54. The non-transitory computer readable medium of claim 52, wherein the subcarrier is associated exclusively with the apparatus.

55. The non-transitory computer readable medium of claim 54, wherein the apparatus is caused to generate the subcarrier by:
generating a complex conjugated symmetric sinusoid waveform with a frequency of the subcarrier, wherein a time duration of the complex conjugated symmetric sinusoid waveform is determined based on a reciprocal of a subcarrier spacing of the set of subcarriers, the number of the set of active terminal devices, and the number of the set of terminal devices; and
adding a cyclic prefix to the complex conjugated symmetric sinusoid waveform.
